(19) United States
(12) Patent Application Publication
(10) Pub. No.: US 2025/0167273 A1
(43) Pub. Date: May 22, 2025

(54) COMPOSITE POLYELECTROLYTE-CERAMIC MEMBRANES

(71) Applicant: Celadyne Technologies, inc., Chicago, IL (US)

(72) Inventors: Erin Castele, Westlake, OH (US); Toru Hatsukade, Evanston, IL (US); Corey Staller, Boise, ID (US); Gary Ong, Temecula, CA (US); Dana A. Kazerooni, Mclean, VA (US)

(21) Appl. No.: 18/870,278

(22) PCT Filed: Jun. 2, 2023
(86) PCT No.: PCT/US23/24348

§ 371 Date: Nov. 27, 2024

Related U.S. Application Data
(60) Provisional application No. 63/433,573, filed on Dec. 19, 2022.
(60) Provisional application No. 63/348,715, filed on Jun. 3, 2022.

(51) Int. Cl. H01M 8/1041; H01M 8/0202; H01M 8/10; H01M 8/1004; H01M 8/1025; H01M 8/1039; H01M 8/1067; H01M 8/1086; H01M 8/12

(52) U.S. Cl. CPC H01M 8/1055; H01M 8/0202; H01M 8/1004; H01M 8/1025; H01M 8/1039; H01M 8/1067; H01M 8/1086; H01M 2008/1095; H01M 2008/1293

(57) ABSTRACT

The present disclosure relates to a bilayer polyelectrolyte membrane, comprising a first layer and a second layer, wherein the first layer comprises a perfluorosulfonic acid, the second layer comprises a metal oxide, and wherein the first layer is disposed on the second layer. The present disclosure further relates to a method of making the bilayer polyelectrolyte membrane, as well as membrane electrode assembly and fuel cell comprising the bilayer polyelectrolyte membrane.

### RELATED APPLICATIONS

This application claims the benefit of U.S. Provisional Applications Nos. 63/348,715 filed Jun. 3, 2022, and 63/433,573 filed Dec. 12, 2022. The entire teachings of each of the above applications are incorporated herein by reference.

### GOVERNMENT SUPPORT

This invention was made with government support under Grant No. DE-SC0021832 awarded by the Department of Energy and under Grant No. DE-AR0001242 awarded by ARPA-E. The government has certain rights in the invention.

### BACKGROUND OF THE INVENTION

Proton exchange membrane-based fuel cells (PEMFCs) are eco-friendly energy conversion devices that operate at low temperatures and are more efficient than existing internal combustion engines. With these advantages, PEMFCs have emerged as a popular alternative to fossil fuels in the transportation industry and have the potential for use in a wide range of applications, such as portable devices and stationary power supply systems.

The proton exchange membrane (PEM) which conducts protons and serves to separate the cathode and the anode is one of the most important elements of a PEMFC. PEMs significantly affect the overall performance of fuel cells; thus, improving the efficiency of a fuel cell requires a PEM that has a high ionic conductivity, has a low fuel crossover, and provides high physicochemical and mechanical stability. Because a PEMFC uses a thin membrane as its electrolyte, these devices are more portable and compact than other types of fuel cells. However, the thin membrane can also allow the crossover of the fuel gas (hydrogen), which negatively affects the cell efficiency. Further, the PEM materials are susceptible to deterioration due to the presence of free radicals such as OH⁻ and OOH⁻ that are formed on the electrodes. Accordingly, PEMs with high ionic conductivity, reduced hydrogen crossover, and stability with respect to radical oxidants are needed.

### SUMMARY OF THE INVENTION

In a first embodiment the invention is a bilayer polyelectrolyte membrane, comprising: a first layer disposed on a second layer, wherein: the first layer comprises a perfluorosulfonic acid (PFSA) polymer, and the second layer comprises crystalline metal oxide.

In a second embodiment, the invention is a method of making a bilayer polyelectrolyte membrane described herein with respect to the first embodiment and various aspects thereof, comprising: providing a first layer having a first side, and a suspension comprising a metal oxide and a solvent; and coating the first side of the first layer with the suspension, thereby producing a coated first layer.

In a third embodiment the invention is a membrane electrode assembly (MEA), comprising: a bilayer polyelectrolyte membrane described herein with respect to the first embodiment and various aspects thereof, a cathode; and an anode, wherein the bilayer electrolyte membrane is disposed between the anode and the cathode.

In a fourth embodiment the invention is a fuel cell, comprising one or more of the MEAs described herein with respect to the third embodiment and various aspects thereof and one or more gas flow bipolar plates.

### BRIEF DESCRIPTION OF THE DRAWINGS

FIG. 1 is a schematic representation of degradation of Nafion® membrane as a result of hydrogen crossover.

FIG. 2 is a schematic representation of reduction in hydrogen crossover due to the presence of a metal oxide-containing layer on top of the PFSA layer, resulting in decreased degradation of the PFSA layer.

FIG. 3 shows a plot demonstrating theoretical calculations of hydrogen crossover and resistance of a PFSA membrane coated with a metal oxide-containing layer as a function of the metal oxide layer thickness.

FIG. 4 shows a cyclic voltammogram of a Nafion® 211 membrane and a membrane comprising a layer of Nafion® 211 coated with a composite layer comprising cerium oxide nanocrystals and 75% crosslinked polyethylene glycol diacrylate (PEG(DA)).

FIG. 5 shows a plot demonstrating fuel cell polarization and power curves of a Nafion® 211 membrane (squares) and a membrane comprising a layer of Nafion® 211 coated with a composite layer comprising cerium oxide nanocrystals and 75% crosslinked PEG(DA) (diamonds).

FIG. 6 shows a plot demonstrating the results of a faster accelerated stress test (FAST) of a Nafion® 211 membrane and a membrane comprising a composite layer comprising cerium oxide nanocrystals and 75% crosslinked PEG(DA).

FIG. 7 shows a schematic representation of a PEM-containing fuel cell.

FIG. 8 shows a plot demonstrating comparison of theoretical calculations as a function of coating thicknesses and measured values of H₂ crossover of a Nafion® 211 membrane and a Nafion® 211 membrane comprising a cerium oxide nanocrystal-crosslinked PEG(DA) layer.

FIG. 9 shows a schematic representation of the radical scavenging mechanism for cerium oxide.

FIG. 10 shows a ¹H NMR spectrum of sPPS.

FIG. 11 shows a cyclic voltammogram of a Nafion® 211 membrane and a membrane comprising a layer of Nafion® 211 coated with a composite layer comprising cerium oxide and crosslinked polyethylene glycol diacrylate (PEG(DA)) (1 μm thick coating comprising 35 v.% 4 nm CeO₂ particles in crosslinked PEG(DA) (75% crosslinked) on Nafion® 211).

FIG. 12 shows a plot demonstrating fuel cell polarization and power curves of a Nafion® 211 membrane (solid squares) and a membrane comprising a layer of Nafion® 211 coated with a composite layer comprising cerium oxide and crosslinked PEG(DA) (empty squares) (1 μm thick coating comprising 35 v.% 4 nm CeO₂ particles in crosslinked PEG(DA) (75% crosslinked) on Nafion® 211).

FIG. 13 shows a plot demonstrating the results of a faster accelerated stress test (FAST) of a Nafion® 211 membrane (squares) and a membrane comprising a composite layer comprising cerium oxide and crosslinked PEG(DA) (diamonds) (1 μm thick coating comprising 35 v.% 4 nm CeO₂ particles in crosslinked PEG(DA) (75% crosslinked) on Nafion® 211).

FIG. 14 shows a plot demonstrating fuel cell polarization and power curves of membranes comprising a layer of Nafion® 211 coated with a composite layer comprising metal oxide and crosslinked PEG(DA) (ZrO₂—circles; MnO₂—squares; TiO₂—diamonds, Nb₂O₃—triangles; 1 μm thick coating comprising 35 v.% 4 nm metal oxide particles in crosslinked PEG(DA) (75% crosslinked) on Nafion® 211).

FIG. 15 shows a plot demonstrating fuel cell polarization and power curves of membranes comprising a layer of Nafion® 211 coated with a composite layer comprising CeO₂ and polyethylenemine crosslinked with dibromopropane (squares) or polyphenylsulphone (PPS) crosslinked with DMSO (circles) (1 μm thick coating comprising 35 v.% 4 nm CeO₂ particles in crosslinked polyethyleneimine (50% crosslinked) or PPS (50% crosslinked) on Nafion® 211).

FIG. 16 shows the values of area specific resistance as measured by electrochemical impedance spectroscopy for a 25 μm Nafion® 211 membrane, a 1 μm thick coating comprising 35 v.% 4 nm CeO₂ particles in crosslinked PEG(DA) (75% crosslinked), and a bilayer membrane comprising a 25 μm Nafion® 211 layer coated with a 1 μm thick coating comprising 35 v.% 4 nm CeO₂ particles in crosslinked PEG(DA) (75% crosslinked).

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

A description of example embodiments of the invention follows.

Hydrogen crossover is an undesirable diffusion of hydrogen from the anode to the cathode through the membrane in a fuel cell. Hydrogen crossover can have at least three effects, including fuel efficiency reduction, cathode potential depression, and aggressive peroxide radical formation. The hydrogen which crosses over can directly react with oxygen at the cathode surface, resulting in a lower cathode potential than that of a lower fuel cell. More severely, this direct reaction between H₂ and O₂ at the cathode can produce peroxide radicals, which not only attack the catalyst layer but also the membrane, causing significant catalyst-layer and membrane degradation. In addition, it has been confirmed that the formation of hot-points or hydrogen peroxide by the highly exothermal chemical reaction between H₂ and O₂ can also lead to pin-holes in membranes, destroying the MEA and causing safety problems. An accelerated sintering of catalysts could be also caused by this hydrogen crossover. The presence of adventitious Cu and Fe further catalyze the breakdown of H₂O₂ into reactive oxygen radicals. To address this root cause, membranes can be made more durable by reducing the hydrogen permeability across the membranes. Ceramics additives can decrease the gas permeability in polymer composites per Maxwell permeability models. For a SiO₂-polyethylene oxide (PEO) system with 35 vol % ceramic content, H₂ permeability is 8 barrers, while polysulfone-PEO random copolymers have H₂ permeability of 2 barrers, compared to that of hydrated Nafion (120 barrers).

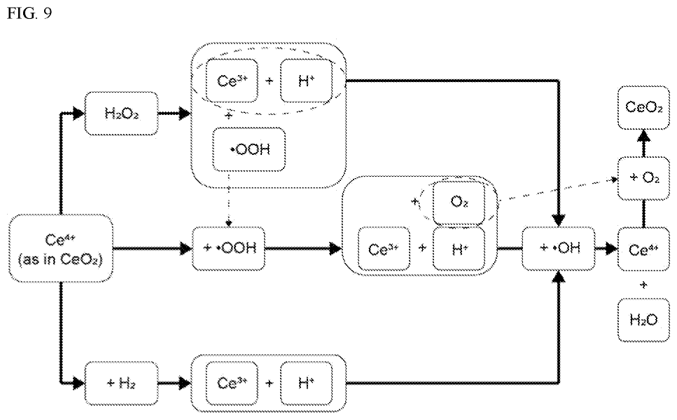

Lifetime is always one of the core concerns of proton exchange membrane fuel cell, especially in commercial utilization. Membrane failure caused by chemical degradation can lead to crash of the whole fuel cell system. Proton exchange membranes with enhanced chemical durability can be fabricated via the addition of free radical scavengers. Free radical scavengers are a series of compounds that can react with harmful radicals preferentially than ionomers, with the membranes protected. In some embodiments, the present disclosure demonstrates that crystalline metal oxides of reducible metals can serve as radical scavengers (see FIG. 9 for the mechanism of radical scavenging by cerium oxide), while serving as proton conductors and reducing hydrogen crossover. Free radical scavenging capacity is dictated by the concentration of scavenging species. Using cerium as a prototypical example, the free radical scavenger can be added either as a cerium salt, crystalline cerium oxide nanoparticles, or amorphous cerium oxide particles. Particles are used over salts to limit cerium migration in the fuel cell in the hydrated environment. Crystalline nanoparticles are used over amorphous particles because the surface crystalline materials can harbor a higher concentration of active Ce³⁺ species due to defect compensation with oxygen vacancies in the system as well as strain from the crystalline lattice. The concentration of active species in the case of metal oxides rather than free cations can be improved by reducing nanoparticle size or introducing strain in the lattice.

Without wishing to be bound by any particular theory, it is believed that interactions between metal oxides and polymers are limited to weak van der waals interactions because the surface of crystalline metal oxides are usually capped with organic ligands after synthesis. To introduce stronger interactions like hydrogen bonding, covalent bonds, and ionic interactions, metal oxides with bare surfaces and active M-O, M-H, and M-OH groups, are preferred. On the side of the polymer, chains with chelating properties like amines, carboxylates, phosphates, and hydroxyls (for hydrogen bonding) are preferred. By introducing stronger interactions, a higher loading of crystalline metal oxides can be achieved without incurring macrophase separation of particles to the free surface, which is advantageous for properties that scale with volume fraction such as conductivity, and gas permeability.

Composites of crystalline metal oxide nanoparticles can exhibit both lower as well as higher gas permeability depending on the pairing of nanoparticle with polymer. Prior work on nanoparticles with weak interactions with the host polymer has shown that composites can exhibit significantly higher gas permeability in the system, though the nanoparticle component is impermeable, because weak interactions cause an increase in polymer free volume in the system. In other words, weak interactions lead to a disordered and gas permeable interface between nanoparticle and polymer that can serve as pathways for fast gas transport in the system.

It has been previously shown that metal oxide/polymer composites without the intentional introduction of salts (usually alkali and alkali earth salts) do not exhibit ion conducting properties. This understanding has been extrapolated to the case of proton conducting systems such that metal oxides are usually added into polymers in the presence of acids or bases (either as a standalone salt like phosphoric acid or anchored to the polymer backbone in the case of polymeric acids). The present disclosure unexpectedly demonstrates that metal oxide/polymer composites can exhibit significant ionic conductivity in the absence of a salt at high humidity likely owing to the intrinsic concentration of protons and hydroxide groups on the metal oxide surface.

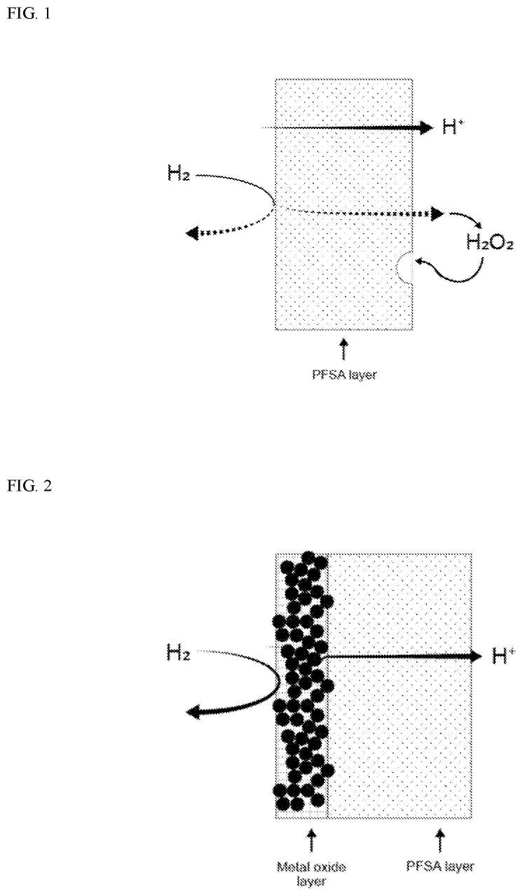

In some embodiments, the present disclosure relates to a bilayer polyelectrolyte membrane which demonstrates reduced hydrogen crossover and improved membrane durability. The membrane comprises a layer of perfluorosulfonic acid (PFSA), such as Nafion®, and a coating comprising a metal oxide. In some embodiments the coating layer comprises the metal oxide, such as cerium oxide, distributed in a polymer matrix. The coating layer has lower hydrogen penetration compared to the PFSA, and reduces levels of peroxide radicals, thus reducing hydrogen crossover through the membrane and improving membrane durability (FIGS. 1 and 2).

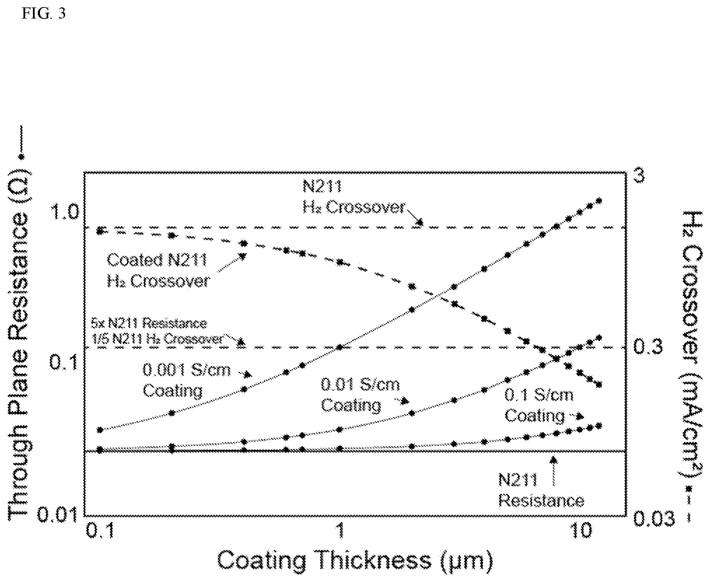

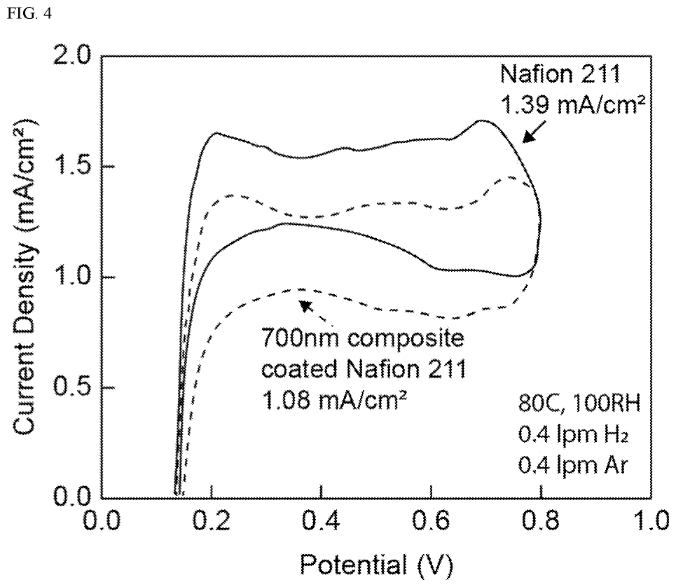

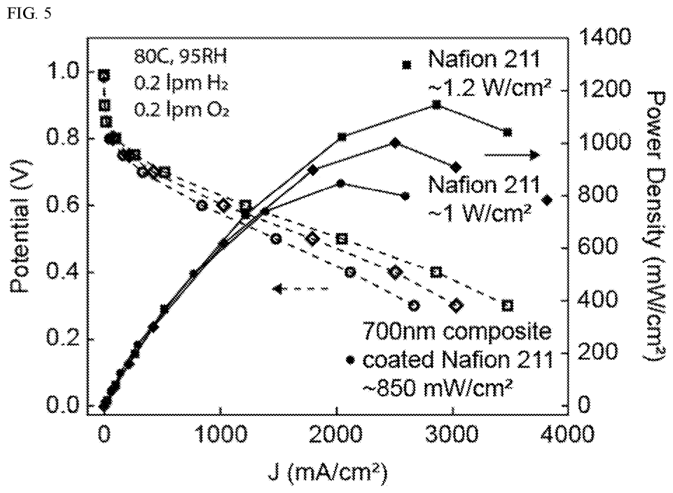

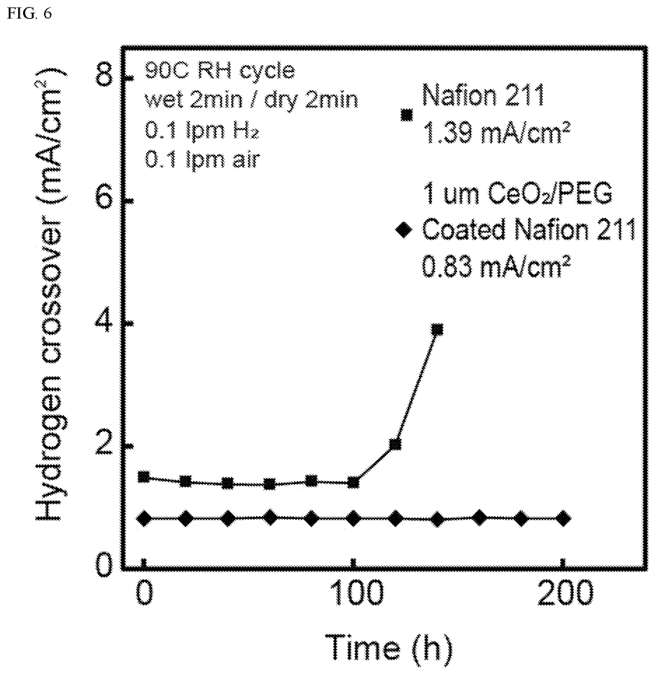

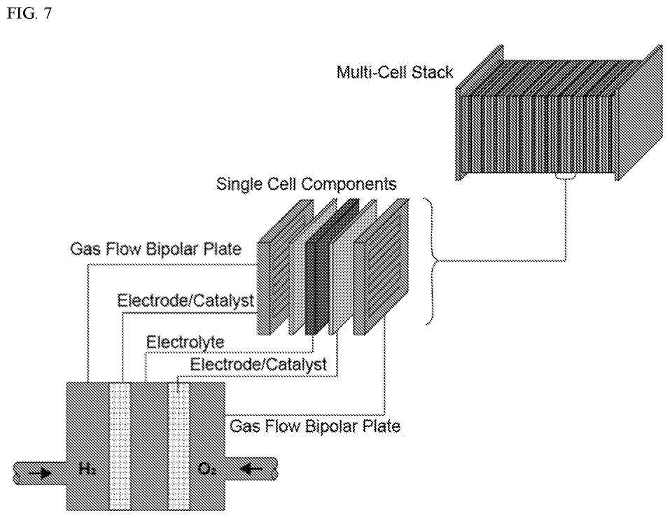

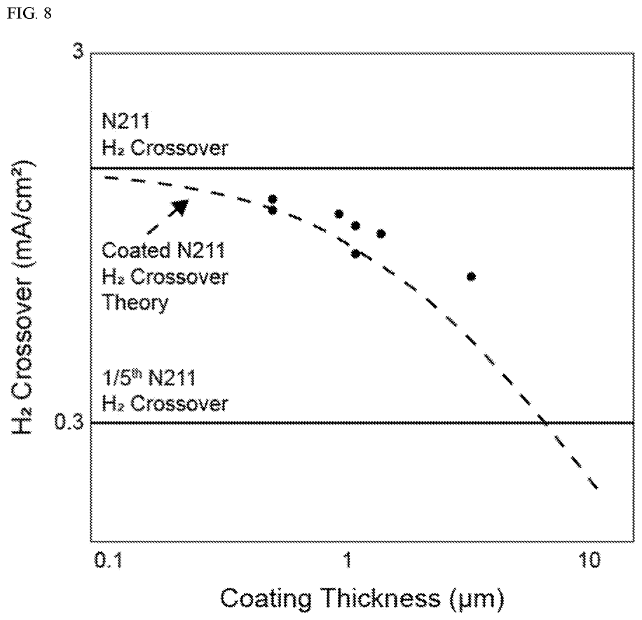

The plot in FIG. 3 demonstrates the design criteria for a coated membrane. The plot shows theoretical calculations of H₂ crossover and resistance of coated PFSA as a function of coating thicknesses. The cyclic voltammogram in FIG. 4 shows hydrogen crossover measurement of Nafion® 211 and Nafion® 211 coated with a 700 nm layer comprising cerium oxide nanocrystals distributed in 75% crosslinked PEG(DA). The plot in FIG. 5 shows fuel cell polarization and power curves of Nafion® 211 and Nafion® 211 coated with a layer consisting of cerium oxide nanocrystals distributed in 75% crosslinked PEG(DA) coating. These data show that the coating reduces H₂ crossover by 25% compared to uncoated Nafion® 211. Furthermore, the results of Faster Accelerated Stress Test (FAST) in FIG. 6 show that the presence of the cerium oxide nanocrystals in crosslinked PEG(DA) coating at least doubles durability of the membrane. The membrane failure time for Nafion® 211 is about 5000 equivalent hours, while for Nafion® 211 with a 1 μm cerium oxide nanocrystals in crosslinked PEG(DA) coating the failure time was not reached during the standard duration of the test which lasted 10,000 equivalent hours. The plot in FIG. 8 shows that the cerium oxide nanocrystals in crosslinked PEG(DA) coating on Nafion® 211 modulates H₂ crossover across a range of coating thicknesses. The plot shows that hydrogen crossover is tunable by varying the coating thickness, and that over 50% reduction in hydrogen crossover has been achieved using various thicknesses of the cerium oxide nanocrystals in crosslinked PEG(DA) coating on Nafion® 211.

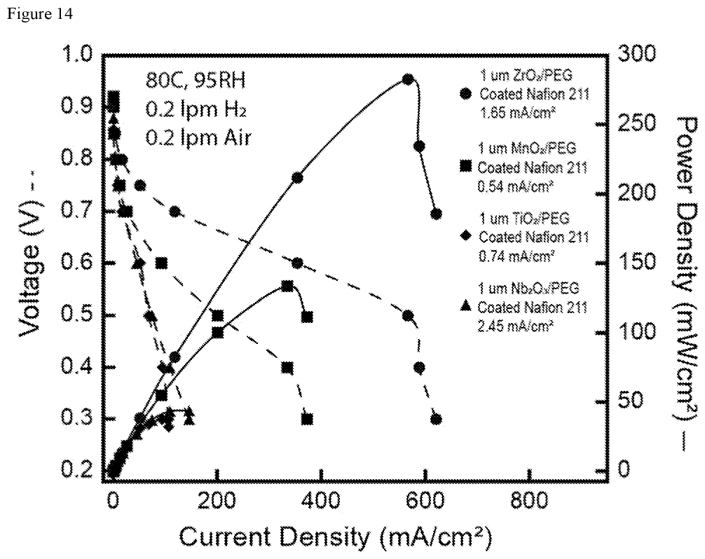

The plot in FIG. 14 shows fuel cell polarization and power curves of membranes comprising a layer of Nafion® 211 coated with a composite layer comprising nanocrystalline ZrO₂, MnO₂, TiO₂, Nb₂O₃, and crosslinked PEG(DA). The data demonstrate that a variety of reducible metal oxide nanocrystals can be used in the bilayer composite membranes.

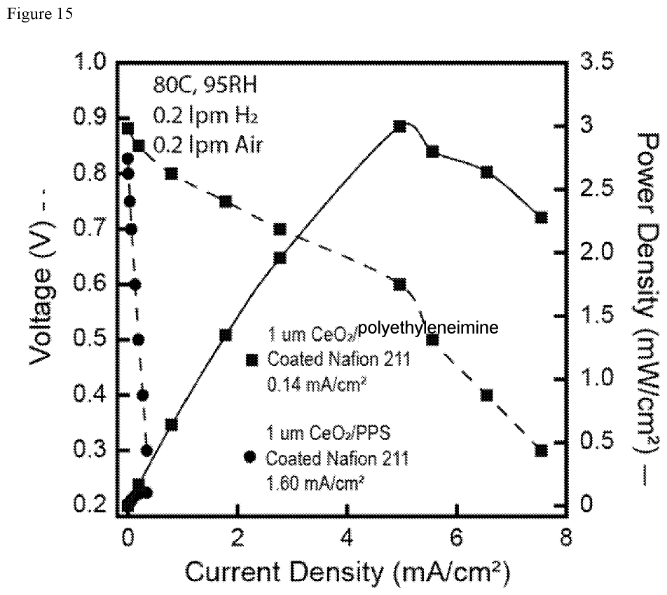

The plot in FIG. 15 shows fuel cell polarization and power curves of membranes comprising plot demonstrating fuel cell polarization and power curves of membranes comprising a layer of Nafion® 211 coated with a composite layer comprising CeO₂ and polyethylenemine crosslinked with dibromopropane or polyphenylsulphone (PPS) crosslinked with DMSO. The data demonstrate that a variety of crosslinked polymers can be used in the bilayer composite membranes.

### Definitions

Numeric ranges are inclusive of the numbers defining the range. For example, “x is an integer between 5 and 14” means that x can be 5, 6, 7, 8, 9, 10, 11, 12, 13, or 14. Measured and measureable values are understood to be approximate, taking into account significant digits and the error associated with the measurement. As used in this application, the terms “about” and “approximately” have their art-understood meanings; use of one vs the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

The term “bilayer polyelectrolyte membrane”, as used herein, refers to a membrane containing two layers disposed on top of each other, each layer comprising a polyelectrolyte. The two layers can adhere to each other through formation of chemical bonds or through Van der Waals interactions.

“Characteristic dimension,” as used herein, refers to a dimension of a crystal that can be measured, for example, by known methods used in the art, including, e.g., microscopy. For spherical crystals, the characteristic dimension is the diameter of the crystal. For non-spherical crystal morphologies, the characteristic dimension of a single crystal can be any dimension selected from the crystal's length, width and height, randomly assigned X, Y, and Z, respectively, including the following options (X═Y═Z), (X≠Y≠Z), (X═Y, X≠Z), (X═Z, X≠Y), (X≠Z, Y═Z)).

The terms “crystal,” “crystals,” or “crystalline” refer to matter whose constituent atoms, molecules or ions are arranged in a substantially uniform, repeating three-dimensional pattern. The pattern can be detected according to known methods used in the chemical arts, including, for example, visual identification of crystals and identification through X-ray diffraction (e.g., Powder X-Ray Diffraction (PXRD) and Single-crystal X-Ray Diffraction (SXRD)).

As used herein, the term “metal oxide” refers to a compound comprising one or more metal cations and oxide anions. Examples of metal oxides include but are not limited to titanium oxide, zirconium oxide, hafnium oxide, vanadium oxide, niobium, tantalum oxide, chromium oxide, molybdenum oxide, tungsten oxide, manganese oxide, iron oxide, cobalt oxide, nickel oxide, cerium oxide, gadolinium oxide, and samarium oxide, as well as oxides of other d-elements and f-elements. As used herein, the term “metal oxide” does not include polyoxometalates. “Polyoxometalate” refers to a material comprising polyatomic ions, usually anions, that consist of three or more transition metal oxyanions linked together by shared oxygen atoms to form closed 3-dimensional frameworks. The metal atoms in polyoxometalates are usually group 6 (Mo, W) or group 5 (V, Nb, Ta) transition metals in their high oxidation states.

As used herein, a “reducible metal oxide” refers to an oxide of a metal that is capable of having a number of different valence (or oxidation) states (e.g., two or more of +1, +2, +3, +4, +5, etc.) in bulk form or as defect states on the surface of the metal oxide. For example, cerium oxide and titanium oxide are reducible oxides, since both Ce and Ti can have oxidations states +3 and +4.

As used herein, the term “dopant” is an element that is introduced in small amounts into a chemical material, such as metal oxide, modifying its optical, electronic, photocatalytic, and other properties. When doped into a crystalline substance, the dopant's atoms are incorporated into the substance's crystal lattice. Dopants include, but are not limited to elements such as Gd, Sm, Nb, Ce, and Si.

As used herein, the term “degree of sulfonation” refers to the number of repeat units that have at least one sulfonic acid/sulfonate salt group. For example, 20% degree of sulfonation indicates a polymer that has 20 percent of its repeat units sulfonated, while 100% degree of sulfonation indicates every repeat unit in the polymer contains one sulfonic acid/sulfonate salt group. This may include polymers that contain multiple sulfonic acid/sulfonate salt groups per repeat unit (e.g., disulfonation, trisulfonation, tetrasulfonation, etc). In some embodiments, the sulfonated polymer can comprise on average 2 sulfonic acid groups per repeat unit, which corresponds to 200% degree of sulfonation. In some embodiments, the sulfonated polymer can comprise on average 2, 3, 4, or 5 sulfonic acid groups per repeat unit, which corresponds to 200%, 300%, 400%, or 500% degree of sulfonation, respectively. In some embodiments, the sulfonated polymer can comprise on average from 1.5 to 2.5 sulfonic acid groups per repeat unit, which corresponds to 150% to 200% degree of sulfonation.

The sulfonated polymers of the disclosure can also be characterized by the average number of sulfonic acid groups per repeat unit. For example, a sulfonated polyphenyl sulfone (sPPS) can comprise 1, 2, 3, 4, 5, 6, 7, or 8 sulfonic acid groups per repeat unit. For example, a repeat unit of sPPS can comprise 2 sulfonic acid groups:

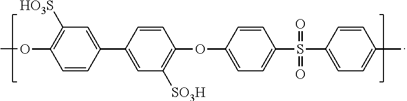

Alternatively, a repeat unit of sPPS can comprise 4 or 6 sulfonic acid groups:

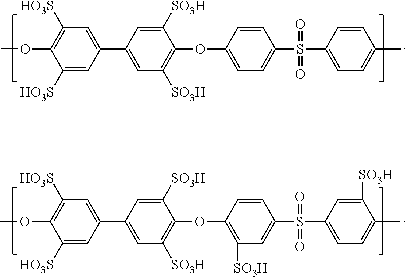

In a given polymer, some repeat units can have, for example, 1 sulfonic acid group, some repeat units can have 2 sulfonic acid groups, and some repeat units can have 3 or more sulfonic acid groups. Accordingly, the number of sulfonic acid groups per repeat unit that is measured in a bulk polymer by analyzing, for example, its ¹H NMR spectrum or ion exchange capacity, corresponds to the average number of sulfonic groups across all the repeat units of the polymer.

As used herein, the term “polyphenyl sulfone” refers to a polymer comprising the following repeat unit:

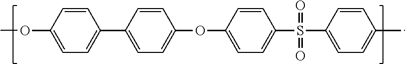

As used herein, the term “polyether ether ketone” refers to a polymer comprising the following repeat unit:

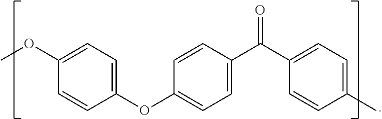

As used herein, the term “polyphosphazine” refers to a polymer comprising the following repeat unit:

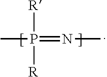

As used herein, the term “polybenzimidazole” refers to a polymer comprising the following repeat unit:

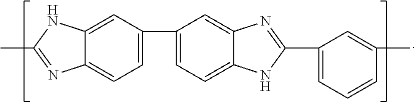

As used herein, the term “polyether sulfone” refers to a polymer comprising the following repeat unit:

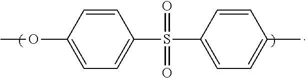

As used herein, the term “polyphenylene oxide” refers to a polymer comprising the following repeat unit:

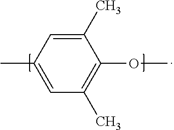

As used herein, the term “polyarylene ether ketone” refers to a polymer comprising one or more of the following repeat units:

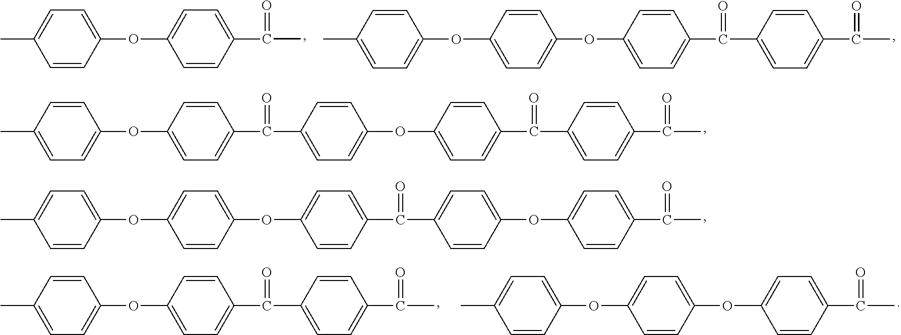

As used herein, the term “poly(sulfone)” refers to a polymer comprising the following repeat unit:

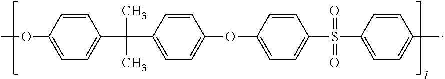

As used herein the term “poly(sulfide sulfone)” refers to a polymer comprising the following repeat unit

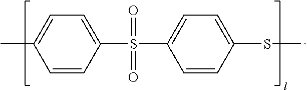

As used herein the term “polyimide” refers to a polymer comprising the following repeat unit:

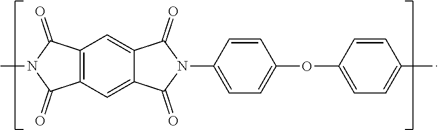

As used herein, the term “poly(etherimide)” refers to a polymer comprising the following repeat unit:

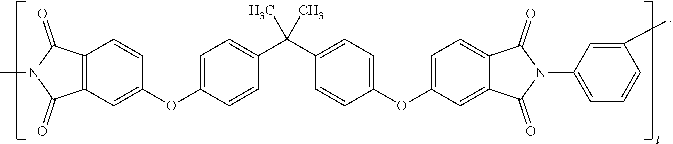

As used herein, the term “polysiloxane” refers to a polymer comprising the following repeat unit:

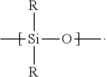

As used herein, the term “polyacrylate” refers to a polymer comprising the following repeat unit:

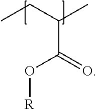

As used herein, the term “poly(ethyle glycol)” refers to a polymer comprising the following repeat unit:

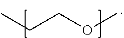

As used herein, the term “poly(ethyle glycol) diacrylate” (PEG(DA)) refers to a polymer represented by the following structural formula:

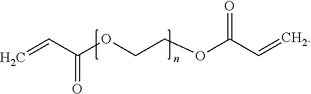

As used herein, the term “polyvinylidene fluoride” refers to a polymer comprising the following repeat unit:

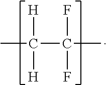

As used herein, the term “polytetrahydrofurane” refers to a polymer comprising the following repeat unit:

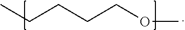

As used herein, the term “polyvinyl butyral” refers to a polymer comprising the following repeat unit:

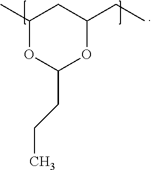

As used herein, the term “poly(acrylonitrile-butadiene-styrene)” refers to a polymer comprising the following repeat units:

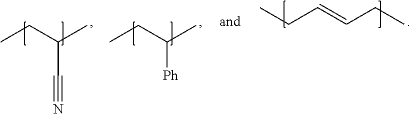

As used herein, the term “polyetherpyridine” refers to a polymer comprising the following repeat unit:

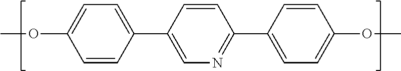

As used herein, the term “poly(ethyleneimine)” refers to a polymer comprising the following repeat unit:

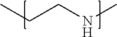

Any of the polymer repeat units described above can have one or more hydrogen atoms substituted with a —CN, —NO₂, —N₃, —OH, F, Cl, Br, I, oxo, —SO₂H, —SO₃H, —OR^{aa}, —NH(R^{aa})₂, —N(R^{aa})₂, —N(R^{aa})₃⁺X⁻, —SH, —SR^{aa}, —C(═O)R^{aa}, —CO₂H, —CHO, —CO₂R^{aa}, —OC(═O)R^{aa}, —OCO₂R^{aa}, —C(═O)N(R^{aa})₂, —OC(═O)N(R^{aa})₂, —NR^{aa}C(═O)R^{aa}, —NR^{aa}CO₂R^{aa}, —NR^{aa}C(═O)N(R^{aa})₂, —C(═NR^{aa})R^{aa}, —C(═O)NRaaSO2R^{aa}, —NR^{aa}SO₂R^{aa}, —SO₂N(R^{aa})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, C₁₋₁₂ alkyl, C₁₋₁₂ alkoxyl, C₁₋₁₂ haloalkyl, C₃₋₁₂ cycloalkyl, 3-16 membered heterocyclyl, and C₆₋₁₂ aryl, wherein X is a counterion and each instance of R^{aa} is, independently, selected from H, —OH, C₁₋₁₀ alkyl, C₁₋₁₀ haloalkyl, C₃₋₁₂ cycloalkyl, 5-16 membered heterocyclyl, and C₆₋₁₂ aryl, or two R^{aa} groups are joined to form a 3-16 membered heterocyclyl.

As used herein, the term “polyalcohol” refers to an alcohol comprising more than one hydroxyl group. Examples of polyalcohols include, but are not limited to, ethylene glycol, propylene glycol, 1,3-propanediol, 1,4-butanediol, glycerol, erythriol, xylitol, hydroquinone, catechol, resorcinol, and phloroglucinol.

As used herein, the term “polyelectrolyte” refers to a polymer comprising repeat units bearing a charged or an ionizable group. Under a particular set of conditions a polyelectrolyte has a net negative or net positive charge. In some embodiments, a polyelectrolyte is or comprises a polycation; in some embodiments, a polyelectrolyte is or comprises a polyanion. Polycations have a net positive charge and polyanions have a net negative charge. The net charge of a given polyelectrolyte may depend on the surrounding chemical conditions, e.g., on the pH.

As used herein, the term “perfluorosulfonic acid” refers to a polymer represented by the following structural formula:

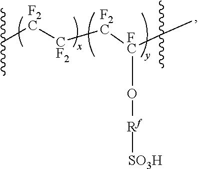

where R^{f} represents a perfluoroalkylene or perfluorooxyalkylene group, and x and y the relative proportion of perfluoro monomer and sulfonated monomer respectively. As used herein, the terms “perfluoroalkylene” or “perfluorooxyalkylene” refer to an alkylene or an oxyalkylene groups in which all hydrogen atoms have been substituted with fluorines. A class of PFSAs is represented by the structural formula (I):

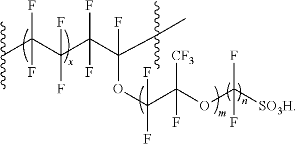

Such PFSAs are usually categorized according to their side-chain length. For example, Aquivion® (formerly Dow SSC) PFSAs are commonly classified as short-side-chain (SSC) PFSAs, while Nafion® is considered as a long-side-chain (LSC) PFSA. Examples of commercial PFSAs include the following:

| PFSA | m | n |
|---|---|---|
| Nafion ® | 1 | 2 |
| Aciplex ® | 0-3 | 2-5 |
| Flemion ® | 0 or 1 | 1-5 |
| 3M ™ | 0 | 4 |
| SSC | 0 | 2 |

As used herein, the term “crosslinking” refers to formation of a covalent or ionic bond between a functional group attached to a polymer main chain and another functional group attached to the same or different main chain, or between a functional group attached to a polymer main chain and a crosslinking reagent.

As used herein, the term “crosslinked polymer” refers to a polymer in which two or more non-adjacent repeat units of the same or different main chains are connected via a crosslinking moiety. The term “crosslinked polymer” also refers to two or more different main chains connected via a plurality of crosslinking moieties.

As used herein, the term “crosslinking moiety” refers a polyvalent, for example, divalent or trivalent, moiety which forms a covalent bond with one or more non-adjacent repeat units of the same polymer main chain or with one or more repeat units of different main chains. A crosslinking moiety can comprise charged groups, for example, an ammonium group, a metal ion, a carboxylate group, or a sulfate group. In some embodiments, a crosslinking moiety is represented by one of the following structural formulas: C₂₋₆ alkylene,

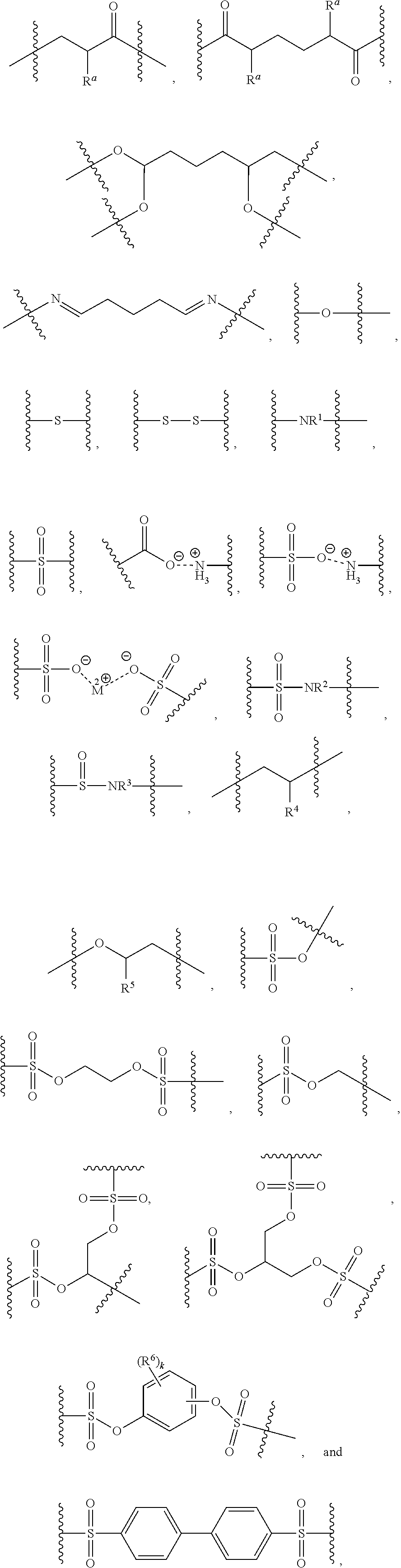

wherein: each of R, R², R³, R⁴, and R⁵ is independently selected from H, C₁₋₁₂ alkyl, C₁₋₁₂haloalkyl, C₆₋₁₄ aryl, and C₆₋₁₄ aryl(C₁₋₁₂ alkylene); R⁶ is H or —SO₃H, R^{a} is H or C₁₋₁₂ alkyl; M²⁺ is selected from Mr²⁺, Ca²⁺, Ba²⁺, and Al(X)²⁺, wherein X is halide, acetate, or nitrate; and the symbol “ [symbol] ” represents a point of attachment of the crosslinking moiety to a repeat unit of the polymer.

As used herein, the term “crosslinking reaction” refers to a chemical reaction between functional groups attached to the repeat units of a polymer and a crosslinking reagent, resulting in formation of a covalent or electrostatic/ionic bonds between the polymer chains and the crosslinking reagent. The polymers of the membranes disclosed herein can comprise one or more functional groups including, but not limited to, NH₂, —CN, —NCO, —N₃, —OH, F, Cl, Br, I, oxo, —SO₂H, —SO₃H, —OCO₂H, —OCO₂Cl, —SH, —CO₂H, —CHO, —CO₂Cl, C₂₋₁₂ alkenyl, and C₂₋₁₂ alkynyl.

As used herein, the term “conditions sufficient for the polymer and the crosslinking reagent to undergo a crosslinking reaction” refers to the external stimuli (e.g. heat, UV light, microwave irradiation, presence of a chemical initiator, such as a radical initiator) as well as time necessary in order to form the crosslinked polymer.

As used herein, the term “degree of crosslinking” in a polymer is defined as the fraction of the functional groups attached to all the chains of that polymer that have reacted to form crosslinking moieties. In some embodiments, the degree of crosslinking is from about 5% to about 95%, from about 10% to about 80%, from about 20% to about 80%, from about 30% to about 70%, from about 40% to about 60%, from about 30% to about 50%, from about 20% to about 50%, from about 40% to about 70%, from about 20% to about 50%, or from about 10% to about 50%.

As used herein, the term “gel fraction (%)” is calculated based on the following equation: [[M(f)/[M(i)]]*100, where M(f) is the dry mass of the membrane exposed to a solvent that dissolves the original polymer and crosslinker, and M(i) is the dry mass of the membrane before exposure to a dissolving solvent. The gel fraction indicates the percent of polymer and linker that remains in the network after exposure to a solvent that dissolves each individual component.

In some embodiments, the gel fraction of the crosslinked first polymer is from about 50% to about 100%. For example, the gel fraction of the crosslinked first polymer is about 50%, about 60%, about 70%, about 80%, about 90%, or about 100%.

As used herein, the term “repeat unit” (also known as a monomer unit) refers to a chemical moiety which periodically repeats itself to produce the complete polymer chain (except for the end-groups) by linking the repeat units together successively. A polymer can contain one or more different repeat units.

As used herein, the “main chain” of a polymer, or the “backbone” of the polymer, is the series of bonded atoms that together create the continuous chain of the molecule. As used herein, a “side chain” of a polymer is the series of bonded atoms which are pendent from the main chain of a polymer.

As used herein, “PFSA and the matrix polymer form an interpenetrating network” refers to a porous matrix that contains PFSA within its pores. A porous matrix can be impregnated with the PFSA, for example, by soaking the matrix in a solution of the PFSA or by spraying a solution of the PFSA on the porous matrix. Alternatively, the porous matrix can be impregnated with a solution of the PFSA monomer, followed by a polymerization reaction within the pores of the matrix.

As used herein, “unsupported membrane” refers to a membrane that contains only the PFSA layer and the metal oxide-comprising layer and does not contain any other layers, supports, or reinforcements.

As used herein, the term “continuous layer” refers to layer that does not contain gaps or openings, such that any point on the layer can be connected to any other point on the layer by a straight line, and each point of that straight line belongs to the layer.

As used herein, the term “glass” refers to an amorphous material that exhibits a glass transition when heated towards the liquid state. The atomic structure of a glass lacks the long-range periodicity observed in crystalline solids. Due to chemical bonding constraints, glasses possess a high degree of short-range order with respect to local atomic polyhedral. Example of glasses include, but are not limited to silicate glass, soda-lime glass, aluminates, phosphates, borates, chalcogenides, fluorides, germinates, and metal oxide glasses such as niobium oxide glass, tantalum oxide glass, tungsten oxide glass, vanadium oxide glass, or molybdenum oxide glass.

As used herein, the term “alkyl” refers to a radical of a straight-chain or branched saturated hydrocarbon group having from 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₅), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

As used herein, the term “alkenyl” refers to a radical of a straight-chain or branched hydrocarbon group having from 2 to 10 carbon atoms and one or more carbon-carbon double bonds (e.g., 1, 2, 3, or 4 double bonds) (“C₂₋₁₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include, without limitation, vinyl (C₂), 1-propenyl (C₃), 2-propenyl (C₃), 1-butenyl (C₄), 2-butenyl (C₄), and the like. Examples of C₂₋₆ alkenyl groups include the aforementioned C₂₋₄ alkenyl groups as well as pentenyl (C₅), hexenyl (C₆), and the like. Additional examples of alkenyl include heptenyl (C₇), octenyl (C₅), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl.

As used herein, the term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂-5 alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkynyl groups include the aforementioned C₂₋₄ alkynyl groups as well as pentynyl (C₅), hexynyl (C₆), and the like. Additional examples of alkynyl include heptynyl (C₇), octynyl (C₅), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“Cio aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

The term “haloalkyl” refers to a substituted alkyl group, wherein one or more of the hydrogen atoms are independently replaced by a halogen, e.g., fluoro, bromo, chloro, or iodo. In some embodiments, the haloalkyl moiety has 1 to 12 carbon atoms (“C₁₋₁₂ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “sulfonic acid group” refers to the following group: —S(O)₂OH.

The term “sulfonate” refers to a salt or ester of sulfonic acid, —S(O)₂OR, where R represents a cation, such as a metal or ammonium cation, or an aliphatic or aromatic substituent. Examples of sulfonates include salts such as lithium sulfonate, sodium sulfonate, potassium sulfonate, or ammonium sulfonate. In some embodiments, the term “sulfonate” refers to an ester of sulfonic acid, for example, an optionally substituted C₁₋₁₂ alkyl sulfonate or an optionally substituted C₆₋₁₂ aryl sulfonate. In some embodiments, R is a multivalent (e.g., bivalent or trivalent) radical forming a covalent or ionic bond with one or more sulfonic acid groups attached to the same or different sulfonated polymer chain, thus forming a crosslinking moiety together with the two or more —S(O)₂O— groups to which it is attached.

The term “sulfonamide” refers to an amide of sulfonic acid, —S(O)₂NRR′, where R and R′ is each a hydrogen or an optionally substituted aliphatic or aromatic substituent, such as optionally substituted C₁₋₁₂ alkyl or an optionally substituted C₆₋₁₂ aryl. In some embodiments, R and/or R′ is each a multivalent (e.g., bivalent or trivalent) radical forming a covalent or ionic bond with one or more sulfonic acid groups attached to the same or different sulfonated polymer chain, thus forming a crosslinking moiety together with the two or more —S(O)₂O— groups to which it is attached.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, and arylene is the divalent moiety of aryl.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that substituents can themselves be substituted, if appropriate. Unless specifically stated as “unsubstituted,” references to chemical moieties herein are understood to include substituted variants. For example, reference to an “aryl” group or moiety implicitly includes both substituted and unsubstituted variants.

Exemplary carbon atom substituents include, but are not limited to, halogen, —CN, —NO₂, —N₃, —OH, F, Cl, Br, I, oxo, —SO₂H, —SO₃H, —OR^{aa}, —NH(R^{aa})₂, —N(R^{aa})₂, —N(R^{aa})₃⁺X−, —SH, —SR^{aa}, —C(═O)R^{aa}, —CO₂H, —CHO, —CO₂R^{aa}, —OC(═O)R^{aa}, —OCO₂R^{aa}, —C(═O)N(R^{aa})₂, —OC(═O)N(R^{aa})₂, —NR^{aa}C(═O)R^{aa}, —NR^{aa}CO₂R^{aa}, —NR^{aa}C(═O)N(R^{aa})₂, —C(═NR^{aa})R^{aa}, —C(═O)NR^{aa}SO₂R^{aa}, —NR^{aa}SO₂R^{aa}, —SO₂N(R^{aa})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, C₁₋₁₂ alkyl, C₁₋₁₂ haloalkyl, 3-16 membered heterocyclyl, and C₆₋₁₂ aryl, wherein X is a counterion and each instance of R^{aa} is, independently, selected from H, —OH, C₁₋₁₀ alkyl, C₁₋₁₀ haloalkyl, C₃₋₁₂ cycloalkyl, 5-16 membered heterocyclyl, and C₆₋₁₂ aryl, or two R^{aa} groups are joined to form a 3-16 membered heterocyclyl.

In a first embodiment the invention is a bilayer polyelectrolyte membrane, comprising: a first layer disposed on a second layer, wherein: the first layer comprises a perfluorosulfonic acid (PFSA) polymer, and the second layer comprises crystalline metal oxide.

In a first aspect of the first embodiment, the PFSA is a polymer comprising a repeat unit represented by structural formula (I):

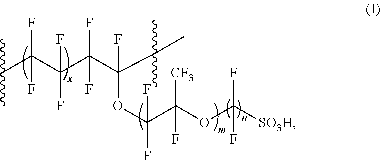

wherein x is an integer between 1 and 15, m is an integer between 0 and 2, n is an integer between 1 and 5, and [symbol] represents a point of attachment to a neighboring repeat unit. For example, x is an integer between 5 and 14, m is 1 or 2, and n is 2 or 3. In certain cases, m is 1 and n is 2.

In a second aspect of the first embodiment, the PFSA is a polymer comprising from about 500 to about 1500 repeat units represented by structural formula (I). For example, the PFSA is a polymer comprising from about 600 to about 1400, from about 700 to about 1300, from about 800 to about 1200, or from about 900 to about 1100 repeat units represented by structural formula (I). For example, the PFSA is a polymer comprising about 1000 repeat units represented by structural formula (I). The remainder of features and example features of the second aspect is as described above with respect to the first aspect of the first embodiment.

In a third aspect of the first embodiment, the metal oxide comprises a reducible metal oxide. For example, the metal oxide comprises, such as consists of, titanium oxide, zirconium oxide, hafnium oxide, vanadium oxide, niobium, tantalum oxide, chromium oxide, molybdenum oxide, tungsten oxide, manganese oxide, iron oxide, cobalt oxide, nickel oxide, cerium oxide, gadolinium oxide, and samarium oxide, or a combination thereof. For example, the metal oxide comprises titanium oxide, zirconium oxide, niobium oxide, and cerium oxide, or a combination thereof. For example, the metal oxide comprises titanium oxide, manganese oxide, niobium oxide, and cerium oxide, or a combination thereof. For example, the metal oxide comprises cerium oxide, such as consists of cerium oxide. For example, the metal oxide is cerium oxide. For example, the metal oxide is zirconium oxide. For example, the metal oxide is manganese oxide. For example, the metal oxide is cerium oxide, zirconium oxide, or manganese oxide. The remainder of features and example features of the third aspect is as described above with respect to the first and second aspects of the first embodiment.

In a fourth aspect of the first embodiment, the metal oxide is doped with one or more dopants. For example, the metal oxide doped with one or more dopants is selected from gadolinium doped cerium oxide, samarium doped cerium oxide, niobium doped titanium oxide, or cerium doped zirconium oxide. For example, the dopant is selected from Si, In, Bi, Al, Y, Ga, Pb, Sn, Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, La, Ce, Pr, Nd, Pm, Sm, Eu, Gd, Tb, Dy, Ho, Er, Tm, Yb, and Lu. For example, the metal oxide comprises from about 0.5 wt. % to about 5 wt. % of the dopant, such as about 0.5 wt. %, about 1 wt. %, about 1.5 wt. %, about 2 wt. %, about 2.5 wt. %, about 3 wt. %, about 3.5 wt. %, about 4.5 wt. %, about 4.5 wt. %, or about 5.0 wt. %. The remainder of features and example features of the fourth aspect is as described above with respect to the first through the third aspects of the first embodiment.

In a fifth aspect of the first embodiment, the metal oxide is in a form of crystalline particles having a characteristic dimension from about 1 nm to about 100 nm. For example, the metal oxide is in a form of crystalline particles having a characteristic dimension of about 1 nm, about 2 nm, about 3 nm, about 4 nm, about 5 nm, about 6 nm, about 7 nm, about 8 nm, about 9 nm, about 10 nm, about 12 nm, about 14 nm, about 16 nm, about 18 nm, about 20 nm, about 25 nm, about 30 nm, about 35 nm, about 40 nm, about 45 nm, about 50 nm, about 60 nm, about 70 nm, about 80 nm, about 690 nm, or about 100 nm. For example, the metal oxide is in a form of crystalline particles having a characteristic dimension from about 2 nm to about 50 nm, from about 3 nm to about 30 nm, or from about 4 nm to about 20 nm. For example, the metal oxide is in a form of crystalline particles having a characteristic dimension from about 2 nm to about 10 nm. For example, the metal oxide is in a form of crystalline particles having a characteristic dimension of about 4 nm. The remainder of features and example features of the fifth aspect is as described above with respect to the first through the fourth aspects of the first embodiment.

In a sixth aspect of the first embodiment, the second layer further comprises a polymer matrix, and the metal oxide is dispersed within the polymer matrix. For example, the second layer comprises from about 5 wt. % to about 85 wt. % of metal oxide. For example, the second layer comprises from about 10 wt. % to about 85 wt. % of metal oxide, from about 15 wt. % to about 85 wt. % of metal oxide, from about 20 wt. % to about 85 wt. % of metal oxide, from about 25 wt. % to about 85 wt. % of metal oxide, from about 30 wt. % to about 85 wt. % of metal oxide, from about 35 wt. % to about 85 wt. % of metal oxide, from about 40 wt. % to about 85 wt. % of metal oxide, from about 45 wt. % to about 85 wt. % of metal oxide, from about 50 wt. % to about 85 wt. % of metal oxide, from about 55 wt. % to about 85 wt. % of metal oxide, from about 60 wt. % to about 85 wt. % of metal oxide, from about 65 wt. % to about 85 wt. % of metal oxide, from about 70 wt. % to about 85 wt. % of metal oxide, or from about 75 wt. % to about 85 wt. % of metal oxide. For example, the second layer comprises about 10 wt. % of metal oxide, about 15 wt. %, about 20 wt. %, about 25 wt. %, about 30 wt. % of metal oxide, about 35 wt. % of metal oxide, about 40 wt. % of metal oxide, about 45 wt. % of metal oxide, about 50 wt. % of metal oxide, about 55 wt. % of metal oxide, about 60 wt. % of metal oxide, about 65 wt. % of metal oxide, about 70 wt. % to of metal oxide, or about 75 wt. % of metal oxide. For example, the second layer comprises from about 30 wt. % to about 45 wt. % of metal oxide. The remainder of features and example features of the sixth aspect is as described above with respect to the first through the fifth aspects of the first embodiment.

In a seventh aspect of the first embodiment, the polymer matrix comprises one or more first polymers selected from a polyether, a polysulfonate, a polysulfone, a poly(imidazole), a polysiloxane, a polyacrylate, a polysulfide, a polyolefin, a polyamide, a poly(triazole), a benzimidazole, a polyester, and a polycarbonate. For example, the one or more first polymers are selected from polyethylene glycol (PEG), polyether ether ketone (PEEK), polytetrahydrofuran, polyvinyl butyral, poly(acrylonitrile-butadiene-styrene), polyetherpyridine, polyphenyl sulfone (PPS), polyphosphazene (POP), polybenzimidazole (PBI), polyether sulfone (PES), polyphenylene oxide (PPO), polyarylene ether ketone (PAEK), polysulfone, poly(sulfide sulfone), polyimide (PI), poly(etherimide) (PEI), polytetrafluoroethylene (PTFE), polyvinylidene fluoride (PVDF), and poly(amine). For example, the one or more first polymers are selected from PEG, PEEK, PPS, PBI, and PVDF. For example, the one or more first polymers are selected from PEG, PPS, poly(ethyleneimine), and PVDF. For example, the one or more first polymers comprise PEG. For example, the first polymer is PEG. For example, the first polymer is PEG diacrylate. The remainder of features and example features of the seventh aspect is as described above with respect to the first through the sixth aspects of the first embodiment.

In an eighth aspect of the first embodiment, the one or more first polymers have molecular weight from about 250,000 g/mol to about 4,000,000 g/mol, such as from about 500,000 g/mol to about 1,000,000 g/mol. For example, the one or more first polymers have molecular weight about 300,000 g/mol, about 400,000 g/mol, about 500,000 g/mol, about 600,000 g/mol, about 700,000 g/mol, about 800,000 g/mol, about 900,000 g/mol, about 1,000,000 g/mol, about 1,500,000 g/mol, about 2,000,000 g/mol, about 2,500,000 g/mol, about 3,000,000 g/mol, or about 3,500,000 g/mol. The remainder of features and example features of the eighth aspect is as described above with respect to the first through the seventh aspects of the first embodiment.

In a ninth aspect of the first embodiment, the one or more first polymers are sulfonated. For example, the first polymer is sulfonated PPS (sPPS). The remainder of features and example features of the ninth aspect is as described above with respect to the first through the eighth aspects of the first embodiment.

In a tenth aspect of the first embodiment, at least one of the one or more first polymers is crosslinked. For example, at least one of the one or more first polymers comprise a crosslinking moiety represented by one of the following structural formulas: C₂₋₆ alkylene,

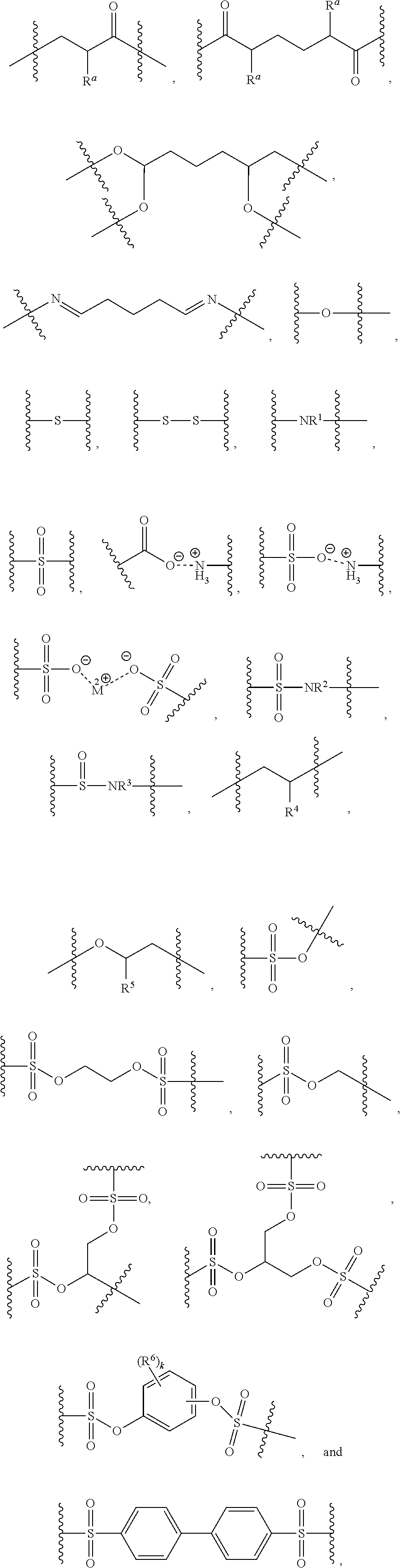

wherein: each of R¹, R², R³, R⁴, and R is independently selected from H, C₁₋₁₂ alkyl, C₁₋₁₂ haloalkyl, C₆₋₁₄ aryl, and C₆₋₁₄ aryl(C₁₋₁₂ alkylene); R^{a} is H or C₁₋₁₂ alkyl; M²⁺ is selected from Mr²⁺, Ca²⁺, Ba²⁺, and Al(X)²⁺, wherein X is halide, acetate, or “ [symbol] ” nitrate; and the symbol represents a point of attachment of the crosslinking moiety to a repeat unit of the one or more first polymer. For example, the crosslinking moiety is represented by one of the following structural formulas:

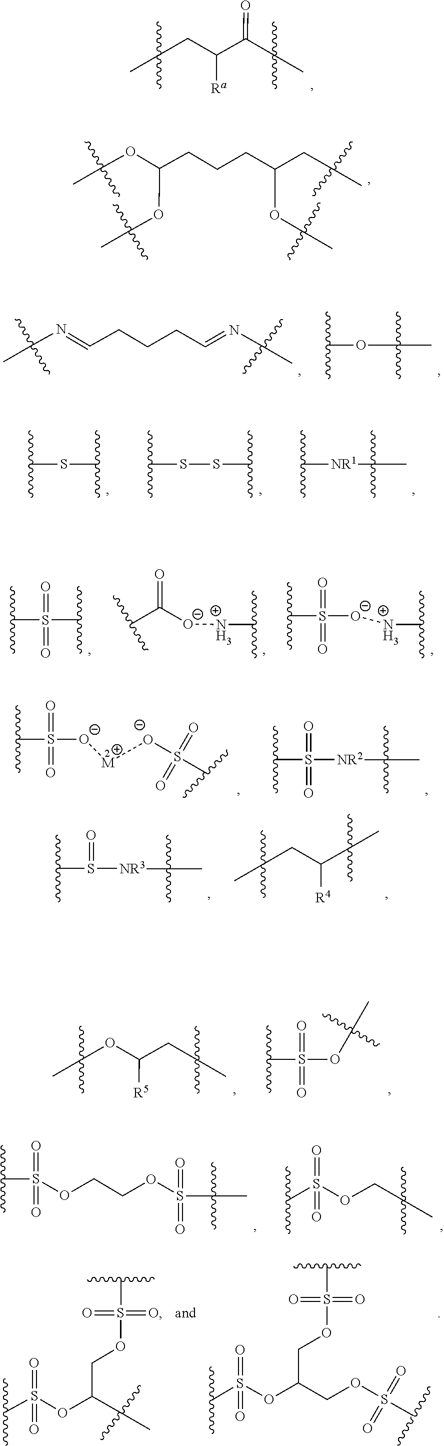

For example, the crosslinking moiety is represented by one of the following structural formulas:

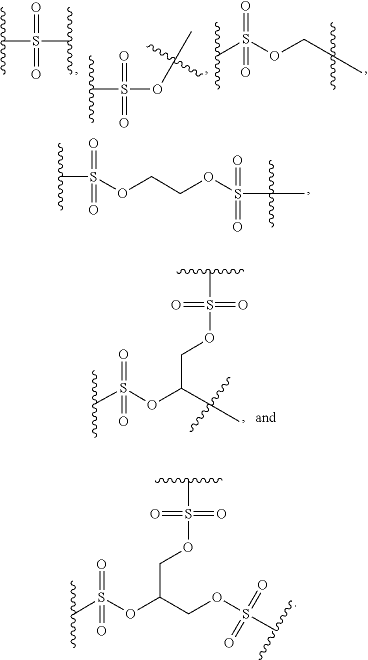

For example, the crosslinking moiety is represented by one of the following structural formulas:

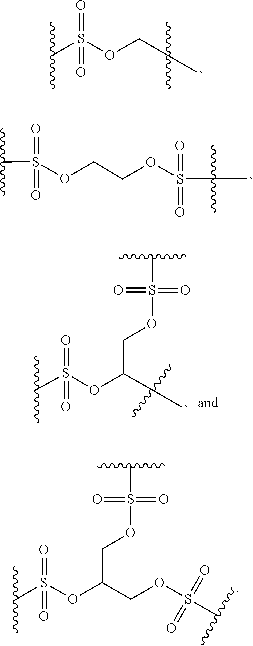 [SMILES: *COS(*)(=O)=O ; *S(=O)(=O)OCCOS(*)(=O)=O ; *C(COS(*)(=O)=O)OS(*)(=O)=O ; *S(=O)(=O)OCC(COS(*)(=O)=O)OS(*)(=O)=O]

For example, the crosslinking moiety is represented by one of the following structural formulas:

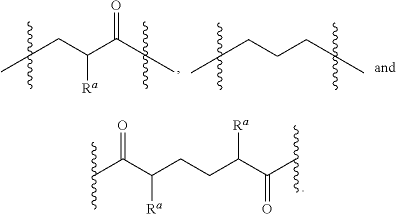

For example, the crosslinking moiety is represented by one following structural formula

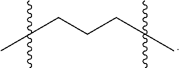 [SMILES: *CCC*]

For example, the first polymer is polyethyleneimine and the crosslinking moiety is represented by one following structural formula

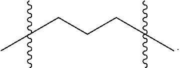 [SMILES: *CCC*]

For example, the crosslinking moiety is represented by the following structural formula:

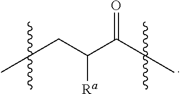

For example, the crosslinking moiety is represented by the following structural formula:

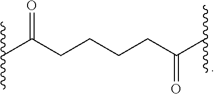 [SMILES: *C(=O)CCCCC(*)=O]

For example, the first polymer is PEG(DA) and the crosslinking moiety is represented by the following structural formula:

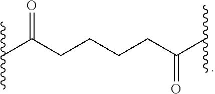 [SMILES: *C(=O)CCCCC(*)=O]

The remainder of features and example features of the tenth aspect is as described above with respect to the first through the ninth aspects of the first embodiment.

In an eleventh aspect of the first embodiment, the first layer further comprises a porous matrix comprising a matrix polymer, wherein the PFSA and the matrix polymer form an interpenetrating network. For example, the first layer comprises from about 50 wt. % to about 99 wt. % of PFSA, from about 55 wt. % to about 98 wt. % of PFSA, from about 60 wt. % to about 97 wt. % of PFSA, from about 70 wt. % to about 96 wt. % of PFSA, or from about 80 wt. % to about 96 wt. % of PFSA. For example, the first layer comprises from about 70 wt. % to about 99 wt. % of PFSA, such as from about 78 wt. % to about 95 wt. % of PFSA. The remainder of features and example features of the eleventh aspect is as described above with respect to the first through the tenth aspects of the first embodiment.

In a twelfth aspect of the first embodiment, the matrix polymer is polytetrafluoroethylene (PTFE). For example, the matrix polymer is expanded PTFE (ePTFE). The remainder of features and example features of the twelfth aspect is as described above with respect to the first through the eleventh aspects of the first embodiment.

In a thirteenth aspect of the first embodiment, the one or more first polymers have a gel fraction from about 50% to about 100%. For example, the gel fraction is about 50%, about 60%, about 70%, about 80%, about 90%, or about 100%. The remainder of features and example features of the thirteenth aspect is as described above with respect to the first through the twelfth aspects of the first embodiment.

In a fourteenth aspect of the first embodiment, the first layer is from about 5 μm to about 200 μm thick. For example, the first layer is about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, or about 170 μm, about 180 μm, about 190 μm, or about 200 μm thick. For example, the first layer is from about 5 μm to about 175 μm thick. For example, first layer is about 25 μm thick. The remainder of features and example features of the fourteenth aspect is as described above with respect to the first through the thirteenth aspects of the first embodiment.

In a fifteenth aspect of the first embodiment, the thickness of the second layer is from about 0.2 μm to about 175 μm. For example, the thickness of the second layer is about 0.2 μm, about 0.4 μm, about 0.6 μm, about 0.8 μm, about 1.0 μm, about 2.0 μm, about 3.0 μm, about 4.0 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, or about 170 μm. For example, the thickness of the second layer is from about 0.2 μm to about 10 μm, from about 0.4 μm to about 5 μm, from about 0.6 μm to about 2 μm, from about 0.8 μm to about 1.5 μm. For example, the thickness of the second layer is about 1 μm. For example, the second layer is from about 0.5 μm to about 1 μm thick. For example, the second layer is about 0.7 μm thick. The remainder of features and example features of the fifteenth aspect is as described above with respect to the first through the fourteenth aspects of the first embodiment.

In a sixteenth aspect of the first embodiment, the first layer is continuous. The remainder of features and example features of the sixteenth aspect is as described above with respect to the first through the fifteenth aspects of the first embodiment.

In a seventeenth aspect of the first embodiment, the membrane is unsupported. The remainder of features and example features of the seventeenth aspect is as described above with respect to the first through the sixteenth aspects of the first embodiment.

In an eighteenth aspect of the first embodiment, the first layer consists of PFSA, wherein the PFSA is a polymer comprising a repeat unit represented by structural formula (I):

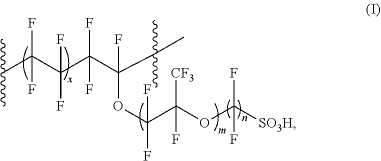

wherein: x is an integer between 5 and 14, m is 1 or 2, and n is 2 or 3; the metal oxide is CeO₂, and the second layer further comprises crosslinked PEG comprising a crosslinking moiety represented by the following structural formula

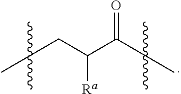

The remainder of features and example features of the eighteenth aspect is as described above with respect to the first through the seventeenth aspects of the first embodiment.

In a nineteenth aspect of the first embodiment, the second layer further comprises a glass, and the metal oxide is dispersed within the glass. For example, the glass comprises niobium oxide, silica, tantalum oxide, tungsten oxide, vanadium oxide, or molybdenum oxide. The remainder of features and example features of the nineteenth aspect is as described above with respect to the first through the eighteenth aspects of the first embodiment.

In a twentieth aspect of the first embodiment, the degree of sulfonation of the first polymer is from about 100% to about 400%. For example, the degree of sulfonation of the first polymer is from about 10% to about 100%, from about 20% to about 100%, from about 30% to about 100%, from about 40% to about 100%, from about 50% to about 100%, from about 60% to about 100%, from about 70% to about 100%, from about 80% to about 100%, from about 50% to about 200%, from about 80% to about 200%, from about 100% to about 200%, from about 100% to about 250%, from about 150% to about 200%, from about 100% to about 300%, from about 100% to about 350%, from about 100% to about 400%, from about 150% to about 250%, from about 150% to about 300%, from about 150% to about 350%, from about 150% to about 400%, from about 200% to about 300%, from about 200% to about 350%, from about 200% to about 400%, or from about 250% to about 350%. For example, the degree of sulfonation of the first polymer is about 20%, about 30%, about 40%, about 50%, about 60%, about 70%, about 80%, about 90%, about 100%, about 120%, about 140%, about 160%, about 180%, about 200%, about 220%, about 240%, about 260%, about 280%, about 300%, about 320%, about 340%, about 360%, about 380%, or about 400%. For example, the degree of sulfonation of the first polymer is from about 100% to about 300%. For example, the degree of sulfonation of the first polymer is about 200%. For example, the first polymer comprises on average from about 1 to about 3 sulfonic acid, sulfonate, and sulfonamide groups, combined, per repeat unit. For example, the first polymer comprises on average about 2 sulfonic acid, sulfonate, and sulfonamide groups, combined, per repeat unit. The remainder of features and example features of the twentieth aspect is as described above with respect to the first through the nineteenth aspects of the first embodiment.

In a twenty-first aspect of the first embodiment, the degree of crosslinking of the first polymer is from about 10% to about 95%. For example, the degree of crosslinking of the first polymer is from about 15% to about 90%, from about 20% to about 80%, from about 20% to about 70%, from about 20% to about 60%, from about 20% to about 50%, from about 20% to about 45%, from about 20% to about 40%, from about 30% to about 50%, from about 25% to about 30%, or from about 30% to about 35%. For example, the degree of crosslinking of the first polymer is about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%. For example, the degree of crosslinking of the first polymer is about 70%. For example, the degree of crosslinking of the first polymer is about 40%. The remainder of features and example features of the twenty-first aspect is as described above with respect to the first through the twentieth aspects of the first embodiment.

In a twenty-second aspect of the first embodiment, the first layer consists of PFSA, wherein the PFSA is a polymer comprising a repeat unit represented by structural formula (I):

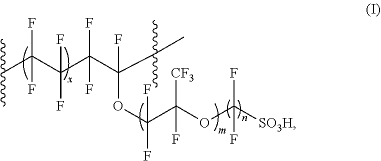

wherein:
x is an integer between 5 and 14,
m is 1 or 2, and
n is 2 or 3;
the metal oxide is CeO₂, and
the second layer further comprises crosslinked PEG(DA) comprising a crosslinking moiety represented by the following structural formula:

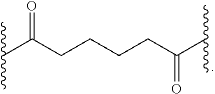 [SMILES: *C(=O)CCCCC(*)=O]

For example, the membrane is unsupported, the crystalline particles of CeO₂ have a characteristic dimension of about 4 nm, and the degree of crosslinking of crosslinked PEG(DA) is about 70%. The remainder of features and example features of the twenty-second aspect is as described above with respect to the first through the twenty-first aspects of the first embodiment.

In a twenty-third aspect of the first embodiment, the membrane is unsupported,
the PFSA is a polymer comprising a repeat unit represented by structural formula (I):

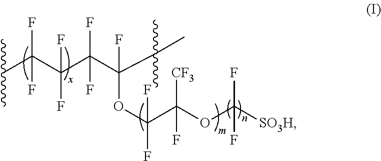

wherein
x is an integer between 5 and 14,
m is 1 or 2, and
n is 2 or 3; and further wherein
the metal oxide is CeO₂,
the second layer further comprises crosslinked sPPS comprising a crosslinking moiety represented by the following structural formula:

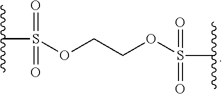 [SMILES: *S(=O)(=O)OCCOS(*)(=O)=O]

the degree of sulfonation of the sPPS is about 200%, and
the degree of crosslinking of the sPPS is about 40%.
   The remainder of features and example features of the twenty-third aspect is as described above with respect to the first through the twenty-second aspects of the first embodiment.

In a twenty-fourth aspect of the first embodiment, the membrane is unsupported, the PFSA is a polymer comprising a repeat unit represented by structural formula (I):

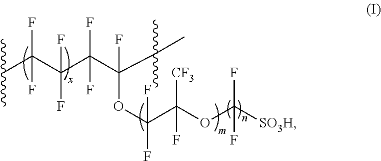

wherein
x is an integer between 5 and 14,
m is 1 or 2, and
n is 2 or 3; and further wherein
the metal oxide is CeO₂,
the second layer further comprises crosslinked sPPS comprising a crosslinking moiety represented by one of the following structural formula:

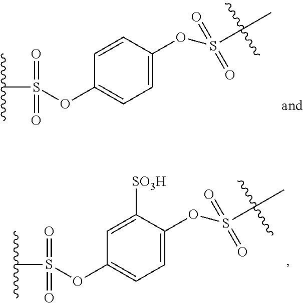 [SMILES: *S(=O)(=O)Oc1ccc(OS(*)(=O)=O)cc1 ; *S(=O)(=O)Oc1ccc(OS(*)(=O)=O)c(S(=O)(=O)O)c1]

the degree of sulfonation of the sPPS is about 200%, and
the degree of crosslinking of the sPPS is from about 25% to about 30.
   The remainder of features and example features of the twenty-fourth aspect is as described above with respect to the first through the twenty-third aspects of the first embodiment.

In a second embodiment, the invention is a method of making a bilayer polyelectrolyte membrane described herein with respect to the first embodiment and various aspects thereof, comprising: providing a first layer having a first side, and a suspension comprising a metal oxide and a solvent; and coating the first side of the first layer with the suspension, thereby producing a coated first layer.

In a first aspect of the second embodiment, the suspension comprises from about from about 0.01 v.% to about 74 v.% of the metal oxide. For example, the suspension comprises from about from about 0.01 v.% to about 1 v.% of the metal oxide, such as from about from about 0.05 v.% to about 1 v.%, from about from about 0.1 v.% to about 0.8 v.%, from about from about 0.2 v.% to about 0.6 v.%, or from about from about 0.05 v.% to about 0.5 v.% of the metal oxide. For example, the suspension comprises about 0.4 v.% of the metal oxide. For example, the suspension comprises about 1 v.% to about 74 v.% of the metal oxide, such as from about 1 v.% to about 74 v.%, from about 10 v.% to about 70 v.%, from about 15 v.% to about 65 v.%, from about 20 v.% to about 60 v.%, from about 25 v.% to about 55 v.%, or from about 30 v.% to about 50 v.% of metal oxide. For example, the suspension comprises about 35 v.% of the metal oxide.

In a second aspect of the second embodiment, the suspension further comprises a first polymer. For example, the suspension comprises from about 0.2 wt. % to about 25 wt. % of the first polymer, such as about 0.5 wt. % of the first polymer. For example, the suspension comprises about 0.2 wt. %, about 0.3 wt. %, about 0.4 wt. %, about 0.6 wt. %, about 0.7 wt. %, about 0.8 wt. %, about 0.9 wt. %, about 1.0 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, or about 20 wt. % of the first polymer. The remainder of features and example features of the second aspect is as described above with respect to the first aspect of the second embodiment.

In a third aspect of the second embodiment, the first polymer comprises a crosslinkable group. For example, the crosslinkable group is selected from OH, NH₂, NH, SH, C(O)OH, C(O)Cl, C(O)Br, NHNH₂, N₃, S(O)₂OH, S(O)₂Cl, —NCO,

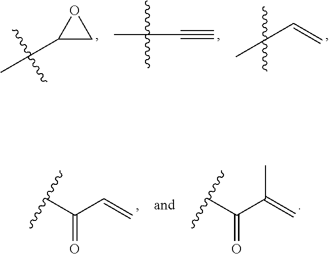

For example, the crosslinkable group is selected from OH, NH₂, SH, C(O)OH, C(O)Cl, C(O)Br, NHNH₂, N₃, S(O)₂OH, S(O)₂Cl, —NCO,

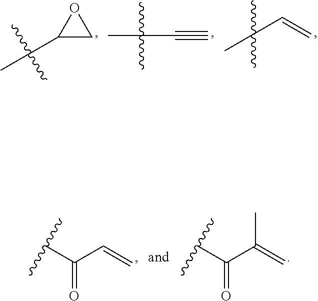

For example, the crosslinkable group is

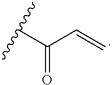 [SMILES: *C(=O)C=C]

For example, the crosslinkable group is NH. For example, the crosslinkable group is S(O)₂OH. The remainder of features and example features of the third aspect is as described above with respect to the first through the second aspects of the second embodiment.

In a fourth aspect of the second embodiment, the suspension further comprises a crosslinking initiator. For example, the crosslinking initiator is selected from 2,2-dimethoxy-2-phenylacetophenone (DMPA), azobisisobutyronitrile (AIBN), and benzoyl peroxide (BPO). The remainder of features and example features of the fourth aspect is as described above with respect to the first through the third aspects of the second embodiment.

In a fifth aspect of the second embodiment, the method further comprises a step of crosslinking the first polymer under conditions sufficient for the crosslinking initiator to initiate the crosslinking of the first polymer. For example, the conditions sufficient for the crosslinking initiator to initiate the crosslinking of the first polymer comprise visible light irradiation, UV light irradiation, application of heat, microwave irradiation, ultrasound, or gamma-ray irradiation. The remainder of features and example features of the fifth aspect is as described above with respect to the first through the fourth aspects of the second embodiment.

In a sixth aspect of the second embodiment, the suspension comprises from about 0.5 wt. % to about 50 wt. % of the crosslinking initiator. For example, the suspension comprises from about 5 wt. % to about 15 wt. % of the crosslinking initiator. For example, the suspension comprises about 0.2 wt. %, about 0.3 wt. %, about 0.4 wt. %, about 0.6 wt. %, about 0.7 wt. %, about 0.8 wt. %, about 0.9 wt. %, about 1.0 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, or about 20 wt. % of the crosslinking initiator. The remainder of features and example features of the sixth aspect is as described above with respect to the first through the fifth aspects of the second embodiment. In a seventh aspect of the second embodiment, the suspension further comprises a crosslinking reagent. For example, the crosslinking reagent is selected from a polyalcohol, an aldehyde, an amine, an epoxide, a thiol, or a compound comprising a terminal alkene or alkyne. For example, the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl)methane, phenylene diamine, 4,4′-thiobisbenzenethiol, and tetrafluoro styrene. For example, the crosslinking reagent is selected from glycerol, ethylene glycol, tetraglycidyl bis(p-aminophenyl)methane, phenylene diamine, 4,4′-thiobisbenzenethiol, glutaraldehyde, styrene, and tetrafluoro styrene. For example, the crosslinking reagent is a polyalcohol, such as glycerol or ethylene glycol. For example, the crosslinking reagent is hydroquinone or 2,5-dihydroxybenzenesulfonic acid. The remainder of features and example features of the seventh aspect is as described above with respect to the first through the sixth aspects of the second embodiment.

In an eighth aspect of the second embodiment, the conditions sufficient for the first polymer and the crosslinking reagent to undergo a crosslinking reaction comprise heating the coated first layer to a crosslinking temperature from about 150° C. to about 200° C. for a crosslinking time from about 2 hours to about 96 hours. For example, the crosslinking temperature is about 150° C., about 160° C., about 170° C., about 180° C., about 190° C., or about 200° C. For example, the crosslinking temperature about is about 180° C. and the crosslinking time is about 4 hours. For example, crosslinking time is about 2 hours, about 3 hours, about 4 hours, about 5 hours, about 6 hours, about 7 hours, about 8 hours, about 9 hours, about 10 hours, about 20 hours, about 30 hours, about 40 hours, about 50 hours, about 60 hours, about 70 hours, about 80 hours, or about 90 hours. For example, crosslinking time is about 4 hours. The remainder of features and example features of the eighth aspect is as described above with respect to the first through the seventh aspects of the second embodiment.

In a ninth aspect of the second embodiment, the coating the first side of the first layer with the suspension comprises spray-coating, spin coating, drop-casting, zone casting, dip coating, blade coating, printing, vacuum filtration, slot die coating, curtain coating, or a combination thereof. For example, the coating the first side of the first layer with the suspension comprises spray-coating. The remainder of features and example features of the ninth aspect is as described above with respect to the first through the eighth aspects of the second embodiment.

In a tenth aspect of the second embodiment, the solvent is selected from dimethylformamide, tetrahydrofuran, N-methylformamide, formamide, acetonitrile, dimethylacetamide, propylene carbonate, ethylene carbonate, N-methylpyrrolidone, dimethylsulfoxide, or a combination thereof. For example, the solvent is dimethylformamide. The remainder of features and example features of the tenth aspect is as described above with respect to the first through the ninth aspects of the second embodiment.

In a third embodiment the invention is a membrane electrode assembly (MEA), comprising: the bilayer polyelectrolyte membrane described herein with respect to the first embodiment and various aspects thereof, a cathode; and an anode, wherein the bilayer electrolyte membrane is disposed between the anode and the cathode.

In a first aspect of the third embodiment, the cathode is disposed on the first layer of the bilayer electrolyte membrane and the anode is disposed on the second layer of the bilayer electrolyte membrane. Alternatively, the anode is disposed on the first layer of the bilayer electrolyte membrane and the cathode is disposed on the second layer of the bilayer electrolyte membrane.

In a fourth embodiment the invention is a fuel cell, comprising one or more of the MEAs described herein with respect to the third embodiment and various aspects thereof and one or more gas flow bipolar plates.

In various embodiments, the present invention is

1. A bilayer polyelectrolyte membrane, comprising:
a first layer disposed on a second layer, wherein:
the first layer comprises a perfluorosulfonic acid (PFSA) polymer, and
the second layer comprises crystalline metal oxide
   2. The bilayer polyelectrolyte membrane of Claim 1, wherein the PFSA polymer comprises a repeat unit represented by structural formula (I):

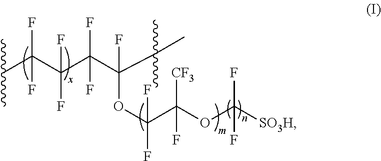

wherein:
   x is an integer between 1 and 15,
   m is an integer between 0 and 2,
   n is an integer between 1 and 5, and
   the symbol [symbol] represents a point of attachment to a neighboring repeat unit.
      3. The bilayer polyelectrolyte membrane of Claim 2, wherein:
x is an integer between 5 and 14,
m is 1 or 2, and
n is 2 or 3.
   4. The bilayer polyelectrolyte membrane of Claim 2 or 3, wherein the PFSA polymer comprises from about 900 to about 1100 repeat units represented by structural formula (I).
   5. The bilayer polyelectrolyte membrane of any one of Claims 1-4, wherein the metal oxide comprises a reducible metal oxide.
   6. The bilayer polyelectrolyte membrane of any one of Claims 1-5, wherein the metal oxide comprises titanium oxide, zirconium oxide, hafnium oxide, vanadium oxide, niobium, tantalum oxide, chromium oxide, molybdenum oxide, tungsten oxide, manganese oxide, iron oxide, cobalt oxide, nickel oxide, cerium oxide, gadolinium oxide, and samarium oxide, or a combination thereof.
   7. The bilayer polyelectrolyte membrane of Claim 5, wherein the metal oxide comprises titanium oxide, zirconium oxide, niobium oxide, and cerium oxide, or a combination thereof.
   8. The bilayer polyelectrolyte membrane of Claim 5, wherein the metal oxide comprises cerium oxide.
   9. The bilayer polyelectrolyte membrane of any one of Claims 1-8, wherein the metal oxide is doped with one or more dopants.
   10. The bilayer polyelectrolyte membrane of Claim 9, wherein the metal oxide doped with one or more dopants is selected from gadolinium doped cerium oxide, samarium doped cerium oxide, niobium doped titanium oxide, or cerium doped zirconium oxide.
   11. The bilayer polyelectrolyte membrane of Claim 9, wherein the metal oxide comprises from about 0.5 wt. % to about 5 wt. % of the dopant.
   12. The bilayer polyelectrolyte membrane of any one of Claims 1-11, wherein the metal oxide is in a form of crystalline particles having a characteristic dimension from about 1 nm to about 100 nm.
   13. The bilayer polyelectrolyte membrane of any one of Claims 1-11, wherein the metal oxide is in a form of crystalline particles having a characteristic dimension from about 2 nm to about 50 nm.
   14. The bilayer polyelectrolyte membrane of any one of Claims 1-13, wherein the second layer further comprises a polymer matrix, and the metal oxide is dispersed within the polymer matrix.
   15. The bilayer polyelectrolyte membrane of Claim 14, wherein the second layer comprises from about 5 wt. % to about 85 wt. % of metal oxide.
   16. The bilayer polyelectrolyte membrane of Claim 14 or 15, wherein the polymer matrix comprises one or more first polymers selected from a polyether, a polysulfonate, a polysulfone, a poly(imidazole), a polysiloxane, a polyacrylate, a polysulfide, a polyolefin, a polyamide, a triazole, a benzimidazole, a polyester, and a polycarbonate.
   17. The bilayer polyelectrolyte membrane of Claim 14 or 15, wherein the one or more first polymers are selected from polyethylene glycol (PEG), polyether ether ketone (PEEK), polytetrahydrofuran, polyvinyl butyral, poly(acrylonitrile-butadiene-styrene), polyetherpyridine, polyphenyl sulfone (PPS), polyphosphazene (POP), polybenzimidazole (PBI), polyether sulfone (PES), polyphenylene oxide (PPO), polyarylene ether ketone (PAEK), polysulfone, poly(sulfide sulfone), polyimide (PI), poly(etherimide) (PEI), polytetrafluoroethylene (PTFE), polyvinylidene fluoride (PVDF), and poly(amine).
   18. The bilayer polyelectrolyte membrane of Claim 14 or 15, wherein the one or more first polymers are selected from PEG, PEEK, PPS, PBI, and PVDF.
   19. The bilayer polyelectrolyte membrane of Claim 16, wherein the first polymer is PEG.
   20. The bilayer polyelectrolyte membrane of any one of Claims 16-19, wherein the one or more first polymers have molecular weight from about 250,000 g/mol to about 4,000,000 g/mol.
   21. The bilayer polyelectrolyte membrane of Claim 20, wherein the one or more first polymers have molecular weight from about 500,000 g/mol to about 1,000,000 g/mol.
   22. The bilayer polyelectrolyte membrane of any one of Claims 16-21, wherein the one or more first polymers are sulfonated.
   23. The bilayer polyelectrolyte membrane of any one of Claims 16-22, wherein at least one of the one or more first polymers is crosslinked.
   24. The bilayer polyelectrolyte membrane of Claim 23, wherein the at least one of the one or more first polymers comprise a crosslinking moiety represented by one of the following structural formulas:

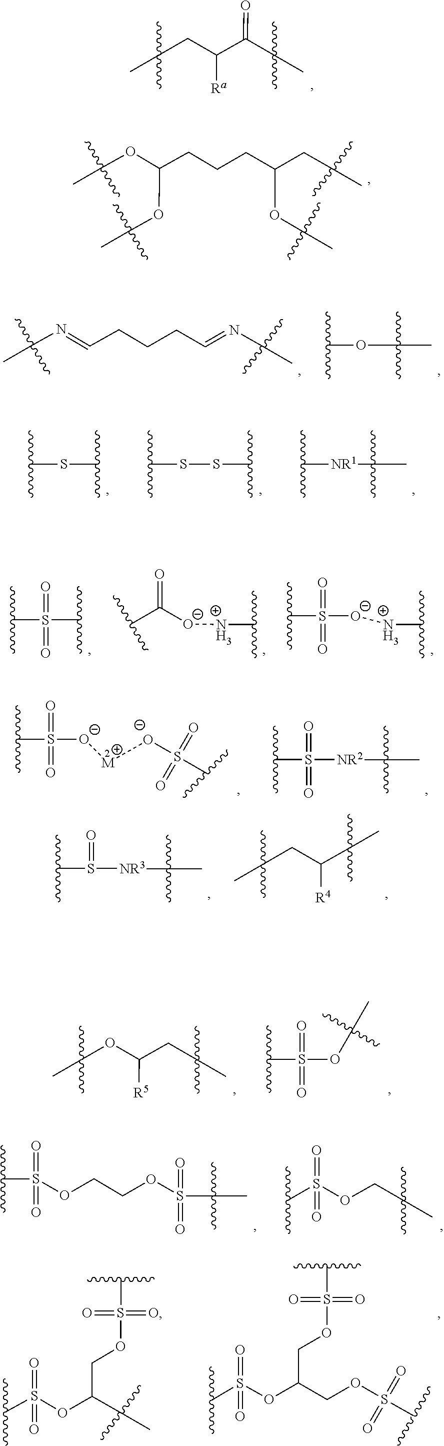

wherein:
   each of R¹, R², R³, R⁴, and R₅ is independently selected from H, C₁₋₁₂ alkyl, C₁₋₁₂haloalkyl, C₆₋₁₄ aryl, and C₆₋₁₄ aryl(C₁₋₁₂ alkylene);
   R^{a} is H or C₁₋₁₂ alkyl;
   M²⁺ is selected from Mr²⁺, Ca²⁺, Ba²⁺, and Al(X)²⁺, wherein X is halide, acetate, or nitrate; and
      the symbol “ [symbol] ” represents a point of attachment of the crosslinking moiety to a repeat unit of the one or more first polymer.
         25. The bilayer polyelectrolyte membrane of Claim 24, wherein the crosslinking moiety is represented by one of the following structural formulas:

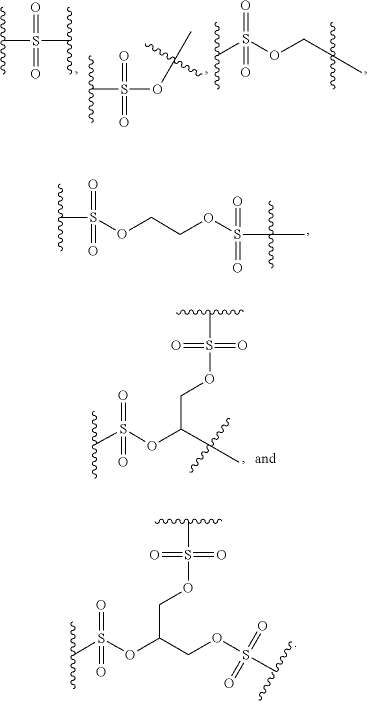

26. The bilayer polyelectrolyte membrane of Claim 24, wherein the crosslinking moiety is represented by the following structural formula:

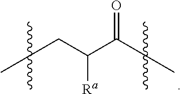

27. The bilayer polyelectrolyte membrane of any one of Claims 1-26, wherein the first layer further comprises a porous matrix comprising a second polymer, and wherein the PFSA polymer and the second polymer form an interpenetrating network.
28. The bilayer polyelectrolyte membrane of Claim 27, wherein the first layer comprises from about 70 wt. % to about 99 wt. % of the PFSA polymer.
29. The bilayer polyelectrolyte membrane of any Claim 27 or 28, wherein the second polymer is PTFE.
30. The bilayer polyelectrolyte membrane of Claim 29, wherein the second polymer is expanded PTFE.
31. The bilayer polyelectrolyte membrane of any one of Claims 23-30, wherein the one or more first polymers have a gel fraction from about 50% to about 100%.
32. The bilayer polyelectrolyte membrane of any one of Claims 1-31, wherein the first layer is from about 5 μm to about 175 μm thick.
33. The bilayer polyelectrolyte membrane of any one of Claims 1-32, wherein the second layer is from about 0.2 μm to about 170 μm thick.
34. The bilayer polyelectrolyte membrane of Claim 33, wherein the second layer is from about 0.2 μm to about 10 μm thick.
35. The bilayer polyelectrolyte membrane of any one of Claims 1-34, wherein the first layer is continuous.
36. The bilayer polyelectrolyte membrane of any one of Claims 1-35, wherein the second layer is continuous.
37. The bilayer polyelectrolyte membrane of any one of Claims 1-36, wherein the membrane is unsupported.
38. The bilayer polyelectrolyte membrane of Claim 1, wherein:
the first layer consists of PFSA, wherein the PFSA is a polymer comprising a repeat unit represented by structural formula (I):

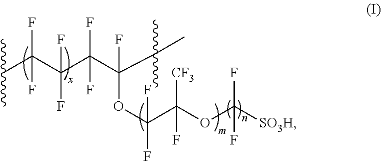

wherein:
   x is an integer between 5 and 14,
   m is 1 or 2, and
   n is 2 or 3;
   the metal oxide is CeO₂, and
   the second layer further comprises crosslinked PEG comprising a crosslinking moiety represented by the following structural formula

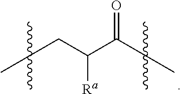

39. The bilayer polyelectrolyte membrane of any one of Claims 1-13, wherein:
the second layer further comprises a glass, and
the metal oxide is dispersed within the glass.
   40. The bilayer polyelectrolyte membrane of Claim 39, wherein the glass comprises niobium oxide, silica, tantalum oxide, tungsten oxide, vanadium oxide, or molybdenum oxide.
   41. A method of making a bilayer polyelectrolyte membrane of any one of Claims 1-38, comprising:
providing a first layer having a first side, and a suspension comprising a metal oxide and a solvent; and
coating the first side of the first layer with the suspension, thereby producing a coated first layer.
   42. The method of Claim 41, wherein the suspension comprises from about 1 v.% to about 74 v.% of the metal oxide.
   43. The method of Claim 42, wherein the suspension comprises about 35 v.% of the metal oxide.
   44. The method of any one of Claims 41-43, wherein the suspension further comprises a first polymer.
   45. The method of Claim 44, wherein the suspension comprises from about 0.2 wt. % to about 25 wt. % of the first polymer.
   46. The method of Claim 45, wherein the suspension comprises about 0.5 wt. % of the first polymer.
   47. The method of any one of Claims 44-46, wherein the first polymer comprises a crosslinkable group.
   48. The method of Claim 47, wherein the crosslinkable group is selected from OH, NH₂, SH, C(O)OH, C(O)Cl, C(O)Br, NHNH₂, N₃, S(O)₂OH, S(O)₂Cl, —NCO,

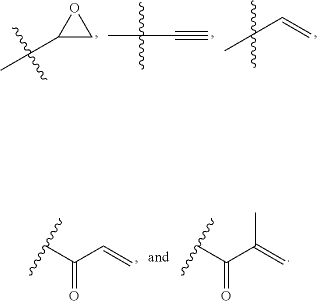

49. The method of Claim 48, wherein the crosslinkable group is

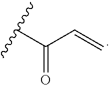 [SMILES: *C(=O)C=C]

50. The method of any one of Claims 41-49, wherein the suspension further comprises a crosslinking initiator.
51. The method of Claim any one of Claims 41-50, further comprising a step of crosslinking the first polymer under conditions sufficient for the crosslinking initiator to initiate the crosslinking of the first polymer.
52. The method of Claim 51, wherein the conditions sufficient for the crosslinking initiator to initiate the crosslinking of the first polymer comprise visible light irradiation, UV light irradiation, application of heat, microwave irradiation, ultrasound, or gamma-ray irradiation.
53. The method of any one of Claims 50-52, wherein the crosslinking initiator is selected from 2,2-dimethoxy-2-phenylacetophenone (DMPA), azobisisobutyronitrile (AIBN), and benzoyl peroxide (BPO).
54. The method of any one of Claims 50-53, wherein the suspension comprises from about 0.5 wt. % to about 50 wt. % of the crosslinking initiator.
55. The method of Claim 54, wherein the suspension comprises about 5 wt. % to about 15 wt. % of the crosslinking initiator.
56. The method of any one of Claims 41-49, wherein the suspension further comprises a crosslinking reagent.
57. The method of any Claim 56, further comprising a step comprising reacting the first polymer with the crosslinking reagent under conditions sufficient for the first polymer and the crosslinking reagent to undergo a crosslinking reaction.
58. The method of Claim 57, wherein the conditions sufficient for the first polymer and the crosslinking reagent to undergo a crosslinking reaction comprise irradiation with visible light, irradiation with UV light, and/or application of heat.
59. The method of Claim 58, the conditions sufficient for the first polymer and the crosslinking reagent to undergo a crosslinking reaction comprise heating the coated first layer to a crosslinking temperature from about 150° C. to about 200° C. for a crosslinking time from about 2 hours to about 96 hours.
60. The method of Claim 59, wherein the crosslinking temperature is about 180° C.
61. The method of Claim 59 or 60, wherein the crosslinking time is about 4 hours.
62. The method of any one of Claims 56-61, wherein the crosslinking reagent is selected from a polyalcohol, an aldehyde, an amine, an epoxide, a thiol, or a compound comprising a terminal alkene or alkyne.
63. The method of any one of Claims 56-61, wherein the crosslinking reagent is selected from glycerol, ethylene glycol, tetraglycidyl bis(p-aminophenyl)methane, phenylene diamine, 4,4′-thiobisbenzenethiol, glutaraldehyde, styrene, and tetrafluoro styrene.
64. The method of Claim 63, wherein the crosslinking reagent is a polyalcohol.
65. The method of Claim 63, wherein the crosslinking reagent is ethylene glycol or glycerol.
66. The method of any one of Claims 41-65, wherein coating the first side of the first layer with the suspension comprises spray-coating, spin coating, drop-casting, zone casting, dip coating, blade coating, printing, vacuum filtration, slot die coating, curtain coating, or a combination thereof.
67. The method of Claim 66, wherein coating the first side of the first layer with the suspension comprises spray-coating.
68. The method of any one of Claims 41-67, wherein the solvent is selected from dimethylformamide, tetrahydrofuran, N-methylformamide, formamide, acetonitrile, dimethylacetamide, propylene carbonate, ethylene carbonate, N-methylpyrrolidone, dimethylsulfoxide, or a combination thereof.
69. The method of Claim 68, wherein the solvent is dimethylformamide.
70. A membrane electrode assembly (MEA), comprising: the bilayer polyelectrolyte membrane of any one of Claims 1-40; a cathode; and an anode, wherein the bilayer electrolyte membrane is disposed between the anode and the cathode.
71. The MEA of Claim 70, wherein the cathode is disposed on the first layer of the bilayer electrolyte membrane and the anode is disposed on the second layer of the bilayer electrolyte membrane.
72. The MEA of Claim 70, wherein the anode is disposed on the first layer of the bilayer electrolyte membrane and the cathode is disposed on the second layer of the bilayer electrolyte membrane.
73. A fuel cell, comprising one or more of the MEAs of any one of Claims 70-72 and one or more gas flow bipolar plates.

### EXAMPLES

### Materials

Nafion® PFSA membrane (NR-211) was purchased from Fuel Cell Store. Sulfuric acid (H₂SO₄) was purchased from Sigma-Aldrich (95-98%, CAS 7664-93-9). Ethylene glycol was purchased from Sigma-Aldrich (≥99%, CAS 107-21-1).

### Example 1. Synthesis of Cerium Oxide Nanocrystals

In a synthesis of 4 nm cerium oxide nanocrystals, 8.68 g of cerium nitrate hexahydrate (20 mmol, Sigma 99.999%) and 53.6 g oleylamine (200 mmol, 90% Acros Organics) was dissolved in 100 ml 1-octadecene (Aldrich 90%). Doping can be introduced by substituting portions of cerium nitrate with an aliovalent dopant such as gadolinium or samanum nitrate. After initial mixing, the solution was stirred under nitrogen at 80° C. for one hour followed by a degassing at 120° C. for one hour under <100 mTorr vacuum. Then, the solution was heated at 10° C./min to 230° C. Once the solution temperature reached 230° C., the solution was further heated to 250° C. and left to react for two hours. After the reaction was completed, the solution was left to cool in air under ca. 80° C. when 50 mL of toluene was added into the solution. The solution was then centrifuged at 1500 rpm for 10 minutes to remove bulk precipitates. The supernatant was mixed with 600 mL of reagent alcohol and centrifuged at 7000 rpm for 10 minutes. The nanocrystals were purified three times post synthesis with a hexane/reagent alcohol combination for dispersion and precipitation, filtered using a 0.2 m PTFE filter, and stored.

### Example 2. Nanocrystal Ligand Exchange

Cerium oxide nanocrystals prepared according to Example 1 suspended in hexane (Aldrich >95% n-hexanes) were purified with four cycles of suspension and precipitation with hexane and reagent alcohol or acetone. The nanocrystal concentration was then diluted to 5 mg/mL, and an equivalent volume of N,N-dimethylformamide (DMF) (Aldrich≥99%) was added to form a two phase mixture. The two-phase mixture was agitated to ensure proper washing of the nanocrystals prior to ligand stripping. If the two phase mixture turned cloudy upon agitation, the nanocrystals were precipitated and washed two more times and the test repeated. If the mixture remained clear and separated back into a two-phase mixture, nitrosyl tetrafluoroborate (Aldrich 95%) in an amount equivalent to half of the approximate weight of nanocrystals in solution was added into the mixture, and the mixture was sonicated for thirty minutes to promote ligand stripping. After the phase transfer from hexane to DMF, the hexane phase was removed and replaced with fresh hexane and shaken. After phase separation, the hexane phase was removed, and this hexane washing was repeated twice more. The nanocrystals in DMF were purified with a DMF/toluene combination for suspension and precipitation, were purified up to six times tracking the DMF/toluene ratio that changes from 1:2, 1:3, 1:4 and finally to a 1 to 6 ratio of DMF to toluene. For the final wash, the nanocrystals were precipitated with toluene and resuspended in anhydrous DMF to be stored.

### Example 3. Polymer Solution and Polymer-Metal Oxide Suspension Preparation

To prepare a typical polymer solution, polymers in the range of 10 to 50 mg were weighted out in a 4 mL glass vial and 1 mL of solvent was added into the vial along with a 0.25 inch stir bar. The solution was then allowed to stir overnight under ambient conditions.

To prepare a composite solution, the ligand stripped nanocrystals were precipitated out of solution using procedures outlined in the purification steps for ligand stripping in Example 2. A volume of the prepared polymer solution from above was added into the centrifuge tube containing the nanocrystal pellet, and the ensemble was sonicated to encourage resuspension.

### Example 4. Spray-Coating of CeO₂—PEG(DA) Suspension on a Layer of Nafion® 211

A Sonotek ExactaCoat was used to deposit a layer of poly(ethylene glycol) diacrylate (PEG(DA)) and cerium oxide (CeO₂) on Nafion®. The spraying suspension prepared as described in Example 3 consisted of 0.5 wt. % PEG(DA)₇₀₀ (50 mg of PEG(DA)) and 0.04 v.% CeO₂ in DMF (35 v.% of CeO₂ with respect to the combined volume of PEG(DA) and CeO₂). The suspension was stirred overnight prior to use. 2,2-dimethoxy-2-phenylacetophenone (DMPA) (10 wt. % with respect to PEG(DA)) was added to the suspension prior to material deposition and stirred for 30 minutes. The Nafion® membrane substrate was held under vacuum during deposition. The ExactaCoat parameters used were: power 0.8-1.3W, nozzle height 40 mm, temperature 80° C., flow rate 0.25-0.5 mL/min. The deposition parameters can vary as follows:
Poly(ethylene glycol) diacrylate molecular weight: PEG(DA) 250-4,000,000
CeO₂ amount: 5 v.%-74 v.%;
substrate temperature: 5° C.-200° C.;
nozzle height: 10 mm-100 mm;
flow rate: 0.25 mL/min-4 mL/min;
power: 0.8W-5W;
crosslinking initiator amount: 0.5 wt. %-50 wt. %.

### Example 5. Spray-Coating of ZrO₂—PEG(DA) Suspension on a Layer of Nafion® 211

Spray-coating was performed as described in Example 4. The spraying suspension prepared as described in Example 3 consisted of 0.5 wt. % PEG(DA)₇₀₀ (50 mg of PEG(DA)) and 0.04 v.% ZrO₂ in ethanol (35 v.% of ZrO₂ with respect to the combined volume of PEG(DA) and ZrO₂). with the following ExactaCoat parameters: power 0.8-1.3W, nozzle height 40 mm, temperature 60° C., flow rate 0.25-0.5 mL/min.

### Example 6. Spray-Coating of MnO₂—PEG(DA) Suspension on a Layer of Nafion® 211

Spray-coating was performed as described in Example 4. The spraying suspension prepared as described in Example 3 consisted of 0.5 wt. % PEG(DA)₇₀₀ (50 mg of PEG(DA)) and 0.04 v.% MnO₂ in ethanol (35 v.% of MnO₂ with respect to the combined volume of PEG(DA) and MnO₂). The following ExactaCoat parameters were used: power 0.8-1.3W, nozzle height 40 mm, temperature 60° C., flow rate 0.25-0.5 mL/min.

### Example 7. Spray-Coating of TiO₂—PEG(DA) Suspension on a Layer of Nafion® 211

Spray-coating was performed as described in Example 4. The spraying suspension prepared as described in Example 3 consisted of 0.5 wt. % PEG(DA)₇₀₀ (50 mg of PEG(DA)) and 0.04 v.% TiO₂ in ethanol (35 v.% of TiO₂ with respect to the combined volume of PEG(DA) and TiO₂). The following ExactaCoat parameters were used: power 0.8-1.3W, nozzle height 40 mm, temperature 60° C., flow rate 0.25-0.5 mL/min.

### Example 8. Spray-Coating of Nb₂O₃-PEG(DA) Suspension on a Layer of Nafion® 211

Spray-coating was performed as described in Example 4. The spraying suspension prepared as described in Example 3 consisted of 0.5 wt. % PEG(DA)₇₀₀ (50 mg of PEG(DA)) and 0.04 v.% Nb₂O₃ in ethanol (35 v.% of Nb₂O₃ with respect to the combined volume of PEG(DA) and Nb₂O₃). The following ExactaCoat parameters were used: power 0.8-1.3W, nozzle height 40 mm, temperature 60° C., flow rate 0.25-0.5 mL/min.

### Example 9. Crosslinking the Metal Oxide-PEG(DA) Layer

The PEG(DA)/metal oxide composite coating on Nafion® prepared according to Examples 4-8 was crosslinked using 2,2-dimethoxy-2-phenylacetophenone (DMPA) as a UV initiator at 10 wt. % in the spray-drying suspension. The crosslinking initiator was added into suspension prior to deposition. The membrane was placed under UV light for 1 hour after deposition. The crosslinking parameters can vary as follows:
Crosslinking time: 15 min-48 hours;
Crosslinking temperature: up to 200° C.
Azobisisobutyronitrile (AIBN) was also used instead of DMPA in solution preparation with equal outcomes.

### Example 10. Spray-Coating of CeO₂-Polyethyleneimine Suspension on a Layer of Nafion® 211

A Sonotek ExactaCoat was used to deposit a layer of polyethylenimine and cerium oxide (CeO₂) on Nafion®. The spraying suspension was prepared according to Example 3 and consisted of 0.5 wt. % polyethyleneimine (60,000 MW) and 0.04 v.% CeO₂ in DMF (35 v.% of CeO₂ with respect to the combined volume of polyethyleneimine and CeO₂). The suspension was stirred overnight prior to use. Dibromopropane (DBP) (30 wt. % with respect to polyethyleneimine) was added to the solution prior to material deposition and used immediately. The Nafion® membrane substrate was held under vacuum during deposition. The ExactaCoat parameters used were: power 0.8-1.3W, nozzle height 40 mm, temperature 80° C., flow rate 0.25-0.5 mL/min. The deposition parameters can vary as follows:
Polyethylenimine molecular weight: 250-4,000,000;
CeO₂ amount: 5 v.%-74 v.%;
substrate temperature: 5° C.-200° C.;
nozzle height: 10 mm-100 mm;
flow rate: 0.25 mL/min-4 mL/min;
power: 0.8W-5W;
crosslinker amount: 10 wt. %-100 wt. %.

### Example 11. Crosslinking the CeO₂-Polyethyleneimine Layer

The polyethyleneimine/CeO₂ composite coating on Nafion® prepared according to Example 10 was crosslinked using DBP as a crosslinker at 30 wt. % in the spray-drying suspension. The crosslinker was added into suspension prior to deposition. The membrane was heated in air to 200° C. for 2 hours after deposition. The crosslinking parameters can vary as follows:
Crosslinking time: 5 min-48 hours;
Crosslinking temperature: up to 250° C.

### Example 12. Spray-Coating of CeO₂—PPS Suspension on a Layer of Nafion® 211

A Sonotek ExactaCoat was used to deposit a layer of polyethylenimine and cerium oxide (CeO₂) on Nafion®. The spraying suspension was prepared according to Example 3 and consisted of 0.5 wt. % PPS (55,000 MW) and 0.04 v.% CeO₂ in 1:1 DMSO/DMF (35 v.% of CeO₂ with respect to the combined volume of polyethyleneimine and CeO₂). The suspension was stirred overnight prior to use. The Nafion® membrane substrate was held under vacuum during deposition. The ExactaCoat parameters used were: power 0.8-1.3W, nozzle height 40 mm, temperature 80° C., flow rate 0.25-0.5 mL/min. The deposition parameters can vary as follows:
PPS molecular weight: 1000-5,000,000;
CeO₂ amount: 5 v.%-74 v.%;
substrate temperature: 5° C.-200° C.;
nozzle height: 10 mm-100 mm;
flow rate: 0.25 mL/min-4 mL/min;
power: 0.8W-5W;
crosslinker amount: 0.5 wt. %-100 wt. %;
DMSO amount: 0.5 v.%-100 v. %.

### Example 13. Crosslinking the CeO₂—PPS Layer

The PPS/CeO₂ composite coating on Nafion® prepared according to Example 12 was crosslinked using residual DMSO from the spray-casting solvent as a crosslinker. The membrane was heated in air to 200° C. for 2 hours after deposition. The crosslinking parameters can vary as follows:
Crosslinking time: 15 min-48 hours;
Crosslinking temperature: up to 250° C.

### Example 14. Preparation of Membrane Electrode Assembly

The bilayer polyelectrolyte membranes was used in a membrane electrode assembly (MEA) and tested in a single fuel cell with 5 cm² active area. For MEA preparation, a 3 inch×3 inch membrane was placed between two gas diffusion electrodes (GDEs), each with an area of 5 cm². The GDEs had pre-deposited catalyst layer on the side of microporous layer and were implemented with the catalyst layer interfacing the membrane. 3 inch×3 inch PTFE gaskets with 5 cm² windows were placed on each side of the membrane to encompass the gas diffusion electrodes to prevent the leak of reactant gases. The gasket thickness is adjusted to allow for 80% compression of the GDEs when the MEA is tightened between two fuel cell end plates.

### Example 15. Testing of Bilayer Polyelectrolyte Membrane in a Fuel Cell

The membrane performance was evaluated in a fuel cell via H₂ crossover measurement, fuel cell polarization curve, and accelerated stress test.

H₂ crossover measurements H₂ crossover was measured by performing cyclic voltammetry where cathode side electrode was scanned between 0.1 V and 0.8 V with a voltage scan rate of 2 mV/s at 80° C. and 100% RH with 0.4 lpm H₂ flow on the anode side and 0.4 lpm Ar flow on the cathode side with no backpressure. Fuel cell polarization curve was measured by conducting constant voltage measurements from open circuit potential to 0.3 V back to open circuit potential at a 0.5 V increment between open circuit potential to 0.7 V and a 1 V increment between 0.7 V to 0.3 V at 80° C. at various RH values with 0.2 lpm H₂ flow on the anode side and 0.2 lpm air or 02 flow on the cathode side with a backpressure of 50 kPa_{g}.

### Electrochemical Impedance Spectroscopy

Electrochemical impedance spectroscopy was performed at 150 mA/cm² with 75 mA/cm² excitation amplitude under H₂ pump mode. Measurements were performed at 80° C. and 100% RH with 0.05 lpm H₂ flow on the anode side and 0.05 lpm Ar flow on the cathode side with no backpressure.

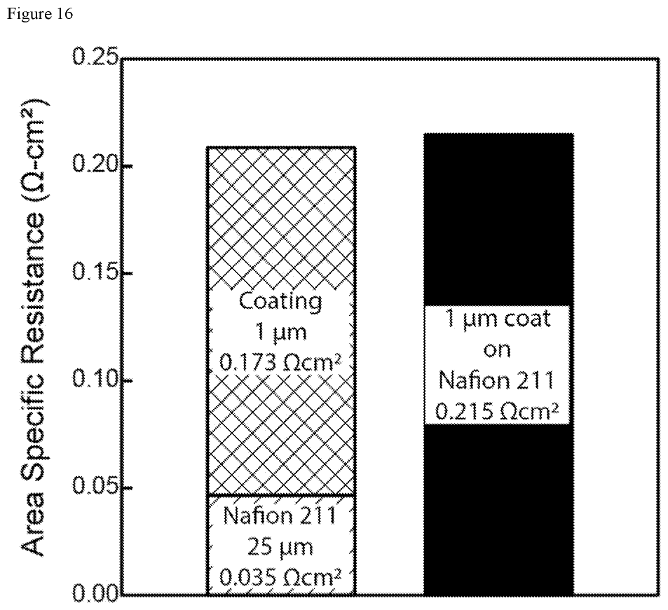

The data in FIG. 16 unexpectedly demonstrate that in a bilayer membrane comprising Nafion® 211 coated with a CeO₂ nancrystls/crosslinked PEG(DA) composite, the composite and Nafion® layers show no contact resistance between each other, which means that a proton experiences no extra resistance by moving between the layers. Contact resistance between hetero-materials is frequently observed in conductive systems and presents a significant barrier to layered geometries. Thus, a bilayer system comprising two materials layered on top of each other is expected to show a drop in ion conductivity due to interfacial/contact resistance. To evaluate contact resistance in the bilayer membrane, the area specific resistances (ASR) of 25 μm Nafion®211 membrane, a 1 μm thick coating comprising 35 v.% 4 nm CeO₂ particles in crosslinked PEG(DA) (75% crosslinked), and a bilayer membrane comprising a 25 μm Nafion® 211 layer coated with a 1 μm thick coating comprising 35 v.% 4 nm CeO₂ particles in crosslinked PEG(DA) (75% crosslinked) were measured in a single cell fuel cell. Unexpectedly, the ASR of the bilayer system was nearly equal to the sum of the ASR values of the individual layers, which means that meaning a proton experiences no extra resistance by moving between the layers.

### Accelerated Stress Tests (ASTs)

Accelerated stress test included an aggressive strenuous phase and a periodic hydration phase, with the duration of each phase amounting to 4.5 h and 0.5 h, respectively. During the aggressive strenuous phase the cell was set to 110° C. with 0.1 lpm H₂ flow on the anode and 0.1 lpm O₂ flow on the cathode with no backpressure, and both gases at 30% RH. During the hydration phase the cell was set to 80° C. with 0.1 lpm H₂ flow on the anode and 0.1 lpm O₂ flow on the cathode with no backpressure, and both gases at 100% RH. H₂ crossover was measured and exhaust water was collected periodically during the accelerated stress test. The results of the tests are shown in FIGS. 4-6.

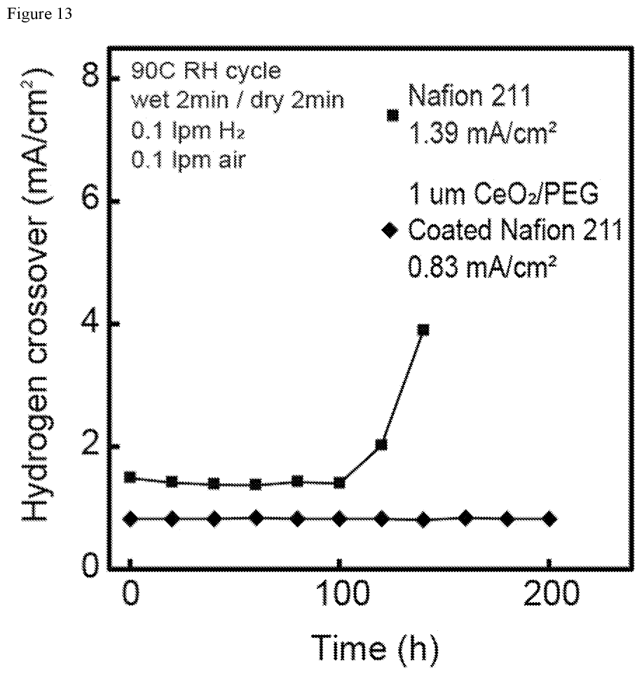

The data in FIG. 13 show that bilayer membranes comprising Nafion® 211 Nafion® 211 coated with a CeO₂ nanocrystals/crosslinked PEG(DA) composite is at least twice as durable a single layer Nafion® 211 membrane.

### Example 16. Determination of Degree of Crosslinking in PEG(DA)-Containing Composites

Degree of crosslinking of PEG(DA)-containing membranes was determined by Fourier Transform Infrared Spectroscopy (FTIR). The change in C═C bond absorption intensity was determined by calculating the area of the IR absorption at ˜1636 cm⁻¹, notated as Integral (C═C). Degree of crosslinking was calculated as follows:

$$Degree of crosslinking ( \% ) = \frac{[ \int {( C = C )}_{Polymer} - \int {( C = C )}_{Crosslinked} ]}{\int {( C = C )}_{Polymer}} * 100$$

Integral (C=C_polymer) refers to C═C absorption before UV or thermal crosslinking and
Integral (C=C_Crosslinked) refers to C═C absorption after UV or thermal crosslinking.

### Example 17. Conductivity Measurements of Freestanding Membranes

Membrane conductivity was measured in 4-point probe geometry in a Scribner Bekktech BT-112 HT conductivity cell with an Admiral Squidstat potentiostat. Conductivity was assessed by current measurements during linear sweep voltammetry from −0.5 V to 0.5 V. Conductivity was then calculated from the current-voltage slope with sample thickness.

### Example 18. Sulfonation of PPS

General Procedure: PPS was sulfonated by reacting the polymer with H₂SO₄. PPS was dissolved in concentrated H₂SO₄ at a concentration 25 mg/mL and stirred at 60-70° C. for 10-48 hrs. The sulfonated polymer was precipitated by adding the reaction mixture dropwise to H₂O at 0° C. The resulting precipitated polymer was centrifuged and isolated. The sulfonated PPS (sPPS) was redispersed in H₂O at room temperature and washed using dialysis until neutral pH was registered. The washed sPPS was dried on a hot plate to provide the final product. The degree of sulfonation of sPPS can be tuned by adjusting the reaction time (1-72 hrs).

Example synthesis: PPS (Radel-5000 NT) was sulfonated by reacting the polymer with H₂SO₄. PPS resin was ground into a powder using an industrial grinder. PPS powder (20 g) was dissolved in concentrated H₂SO₄ at a concentration 25 mg/mL and stirred at 60° C. for 8 hrs. The resulting sulfonated polymer was precipitated by adding the reaction mixture dropwise to H₂O at 0° C. The resulting precipitated polymer was centrifuged and isolated. The sulfonated PPS (sPPS) was redispersed in H₂O at room temperature and washed using dialysis until neutral pH was registered. The washed sPPS was dried on a hot plate to provide the final product. The yield of the reaction was determined by mass to be 910%. The resulting product had a titration determined IEC of 3.605 meq/g (corresponding to 2.0 sulfonic acids per repeat unit), as measured according to the procedure described in Example 3.

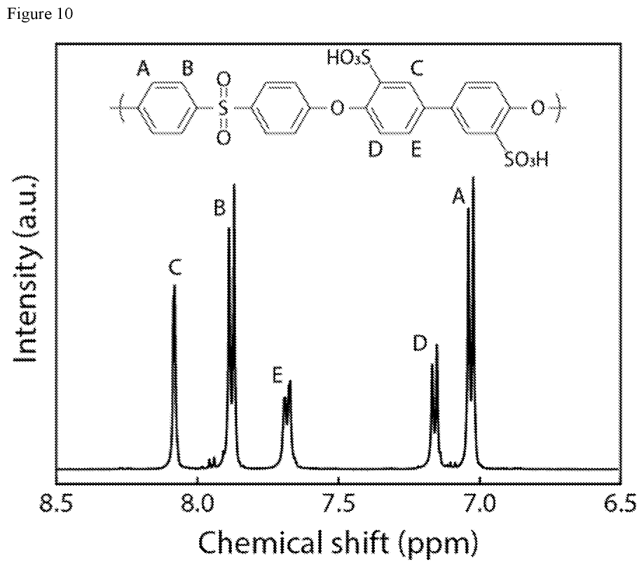

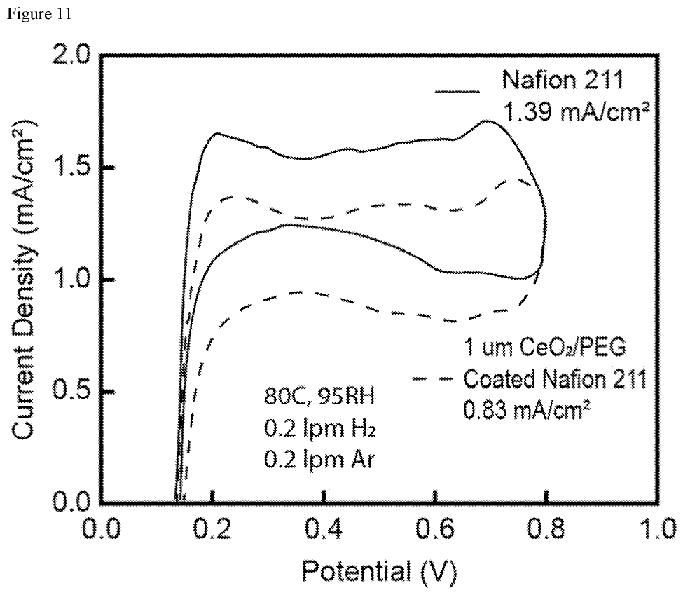

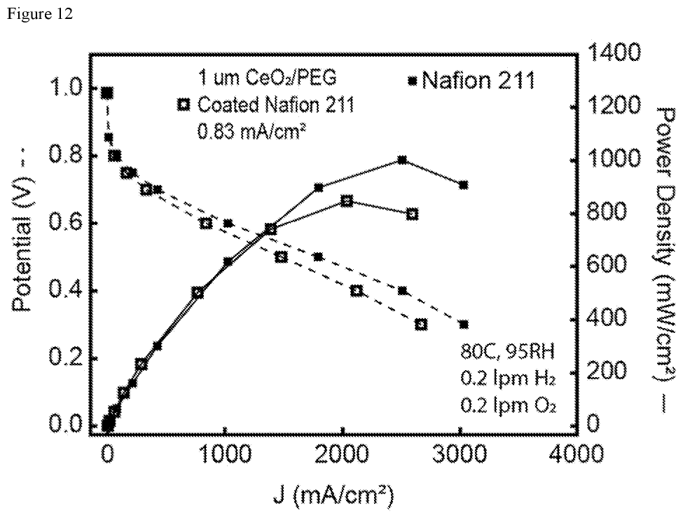

¹H NMR of the sulfonated polymers was measured at a concentration of about 10 wt. % in DMSO-d6 to confirm the polymer structure and degree of sulfonation. The ¹H NMR spectrum was acquired with a 500 MHz Bruker Ultrashield 500 Plus Spectrometer and processed using SpinWorks 4. The ¹H NMR experiments were performed using a pulse angle of 30° and a pulse delay of 5s with 32 scans. The ¹H NMR spectrum of the prepared sPPS is shown in FIG. 10. Integration of the peaks as shown below in Table 1 was used to establish the number and positions of the sulfonic acid groups in the repeat unit as shown in FIG. 10.

TABLE 1
¹H NMR peak integrals for sPPS, ¹H NMR IEC values,
and IEC value determined by titration.

| Peak Identity | A | B | C | D | E |
|---|---|---|---|---|---|
| Peak Integrations | 4.03 | 4 | 2.05 | 2 | 2.12 |
| (H/RU) | | | | | |
| Ratio with peak C | 0.51 | 0.51 | — | 1.02 | 0.97 |
| Sulfonic acids per RU | 2.03 | 2.05 | — | 2.05 | 1.93 |
| IEC (meq/g) | 3.59 | 3.61 | — | 3.61 | 3.46 |
| Average NMR IEC | 3.57 | | | | |
| Titration IEC | 3.61 | | | | |

Peaks were integrated and normalized by setting the peak integration of peak B to a value of 4, which is the number of B site protons per repeat unit (Table 1). The identity of peak B is assigned based on the steric and electronic protection of the B sites from sulfonation by the presence of the sulfone linkage. The number of sulfonic acid moieties per repeat unit was calculated by the ratio of peak integrations with peak C. Further, IEC values were calculated based on the peak integration values as follows. The value of IEC is related to the weight of material per sulfonic acid moieties. This is known as the effective weight (EW). Since the prepared sPPS has a monopolymer backbone, a ratio of the C peak integral (which matched the number of the sulfonic acid groups in the structure) with any hydrogen peak was used to calculate sulfonic acids per repeat unit using the following equation:

$$\frac{{SO}_{3} H}{R U} = \frac{\int C peak}{\int Reference peak} * [ Number of reference H per RU ]$$

The number of sulfonic acid moieties per repeat unit was converted to EW according following equation:

$$E W = \frac{{MW}_{RU}}{[ \frac{{SO}_{3} H}{RU} ]} + {MW}_{S {O}_{3} H} ,$$

where MW_{RU} is the molecular weight of the repeat unit (400 g/mol for PPS) and MW_{SO}_{₃}_{H} is the molecular weight of a sulfonic acid moiety (82 g/mol). EW was then converted to IEC as follows:

$$IEC = \frac{1000}{EW}$$

The obtained numbers for IEC based on each of the integrated peaks in the ¹H NMR spectrum of sPPS, as well as the average number, are in excellent alignment with the experimental IEC value obtained by titration (see Table 1). This alignment demonstrates that there are no other significant sulfonation locations on the repeat unit, and that the sPPS contains two sulfonic acid moieties per repeat unit, which are located on the biphenyl portion of the backbone as shown in FIG. 10.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A bilayer polyelectrolyte membrane, comprising:
a first layer disposed on a second layer, wherein:
the first layer comprises a perfluorosulfonic acid (PFSA) polymer, and
the second layer comprises crystalline metal oxide.

2. The bilayer polyelectrolyte membrane of claim 1, wherein the PFSA polymer comprises a repeat unit represented by structural formula (I): 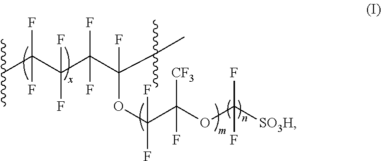
wherein:
x is an integer between 1 and 15,
m is an integer between 0 and 2,
n is an integer between 1 and 5, and
the symbol [symbol] represents a point of attachment to a neighboring repeat unit.

3. The bilayer polyelectrolyte membrane of claim 2, wherein:
x is an integer between 5 and 14,
m is 1 or 2, and
n is 2 or 3.

4. The bilayer polyelectrolyte membrane of claim 2 or 3, wherein the PFSA polymer comprises from about 900 to about 1100 repeat units represented by structural formula (I).

5. The bilayer polyelectrolyte membrane of any one of claims 1-4, wherein the metal oxide comprises a reducible metal oxide.

6. The bilayer polyelectrolyte membrane of any one of claims 1-5, wherein the metal oxide comprises titanium oxide, zirconium oxide, hafnium oxide, vanadium oxide, niobium, tantalum oxide, chromium oxide, molybdenum oxide, tungsten oxide, manganese oxide, iron oxide, cobalt oxide, nickel oxide, cerium oxide, gadolinium oxide, and samarium oxide, or a combination thereof.

7. The bilayer polyelectrolyte membrane of claim 5, wherein the metal oxide comprises titanium oxide, zirconium oxide, niobium oxide, and cerium oxide, or a combination thereof.

8. The bilayer polyelectrolyte membrane of claim 5, wherein the metal oxide comprises titanium oxide, manganese oxide, niobium oxide, and cerium oxide, or a combination thereof.

9. The bilayer polyelectrolyte membrane of claim 5, wherein the metal oxide comprises cerium oxide.

10. The bilayer polyelectrolyte membrane of claim 5, wherein the metal oxide is cerium oxide.

11. The bilayer polyelectrolyte membrane of any one of claims 1-10, wherein the metal oxide is doped with one or more dopants.

12. The bilayer polyelectrolyte membrane of claim 11, wherein the metal oxide doped with one or more dopants is selected from gadolinium doped cerium oxide, samarium doped cerium oxide, niobium doped titanium oxide, or cerium doped zirconium oxide.

13. The bilayer polyelectrolyte membrane of claim 11, wherein the metal oxide comprises from about 0.5 wt. % to about 5 wt. % of the dopant.

14. The bilayer polyelectrolyte membrane of any one of claims 1-13, wherein the metal oxide is in a form of crystalline particles having a characteristic dimension from about 1 nm to about 100 nm.

15. The bilayer polyelectrolyte membrane of any one of claims 1-13, wherein the metal oxide is in a form of crystalline particles having a characteristic dimension from about 2 nm to about 50 nm.

16. The bilayer polyelectrolyte membrane of claim 15, wherein the crystalline particles have a characteristic dimension from about 2 nm to about 10 nm.

17. The bilayer polyelectrolyte membrane of claim 15, wherein the crystalline particles have a characteristic dimension of about 4 nm.

18. The bilayer polyelectrolyte membrane of any one of claims 1-17, wherein the second layer further comprises a polymer matrix, and the metal oxide is dispersed within the polymer matrix.

19. The bilayer polyelectrolyte membrane of claim 18, wherein the second layer comprises from about 5 wt. % to about 85 wt. % of metal oxide.

20. The bilayer polyelectrolyte membrane of claim 18, wherein the second layer comprises from about 30 wt. % to about 45 wt. % of metal oxide.

21. The bilayer polyelectrolyte membrane of any one of claims 18-20, wherein the polymer matrix comprises one or more first polymers selected from a polyether, a polysulfonate, a polysulfone, a poly(imidazole), a polysiloxane, a polyacrylate, a polysulfide, a polyolefin, a polyamide, a poly(triazole), a benzimidazole, a polyester, and a polycarbonate.

22. The bilayer polyelectrolyte membrane of any one of claims 18-20, wherein the one or more first polymers are selected from poly(ethylene glycol) (PEG), polyether ether ketone (PEEK), polytetrahydrofuran, polyvinyl butyral, poly(acrylonitrile-butadiene-styrene), polyetherpyridine, polyphenyl sulfone (PPS), polyphosphazene (POP), polybenzimidazole (PBI), polyether sulfone (PES), polyphenylene oxide (PPO), polyarylene ether ketone (PAEK), polysulfone, poly(sulfide sulfone), polyimide (PI), poly(etherimide) (PEI), polytetrafluoroethylene (PTFE), polyvinylidene fluoride (PVDF), and poly(amine).

23. The bilayer polyelectrolyte membrane of any one of claims 18-20, wherein the one or more first polymers are selected from PEG, PEEK, PPS, PBI, and PVDF.

24. The bilayer polyelectrolyte membrane of any one of claims 18-20, wherein the one or more first polymers are selected from PEG, PPS, poly(ethyleneimine), and PVDF.

25. The bilayer polyelectrolyte membrane of claim 24, wherein the one or more first polymers comprise PEG.

26. The bilayer polyelectrolyte membrane of claim 24, wherein the first polymer is PEG.

27. The bilayer polyelectrolyte membrane of claim 25, wherein the first polymer is PEG-diacrylate (PEG(DA)).

28. The bilayer polyelectrolyte membrane of any one of claims 21-27, wherein the one or more first polymers have molecular weight from about 250,000 g/mol to about 4,000,000 g/mol.

29. The bilayer polyelectrolyte membrane of claim 28, wherein the one or more first polymers have molecular weight from about 500,000 g/mol to about 1,000,000 g/mol.

30. The bilayer polyelectrolyte membrane of any one of claims 21-24 and 28-29, wherein the one or more first polymers are sulfonated.

31. The bilayer polyelectrolyte membrane of claim 22 or 30, wherein the first polymer is sulfonated PPS (sPPS).

32. The bilayer polyelectrolyte membrane of claims 30 or 31, wherein the degree of sulfonation of the first polymer is from about 100% to about 300%.

33. The bilayer polyelectrolyte membrane of claim 32, wherein the degree of sulfonation of the first polymer is about 200%.

34. The bilayer polyelectrolyte membrane of any one of claims 30-33, wherein the first polymer comprises on average from about 1 to about 3 sulfonic acid, sulfonate, and sulfonamide groups, combined, per repeat unit.

35. The bilayer polyelectrolyte membrane of claim 34, wherein the first polymer comprises on average about 2 sulfonic acid, sulfonate, and sulfonamide groups, combined, per repeat unit.

36. The bilayer polyelectrolyte membrane of any one of claims 21-35, wherein at least one of the one or more first polymers is crosslinked.

37. The bilayer polyelectrolyte membrane of claim 36, wherein the at least one of the one or more first polymers comprise a crosslinking moiety represented by one of the following structural formulas:
C₂₋₆ alkylene, 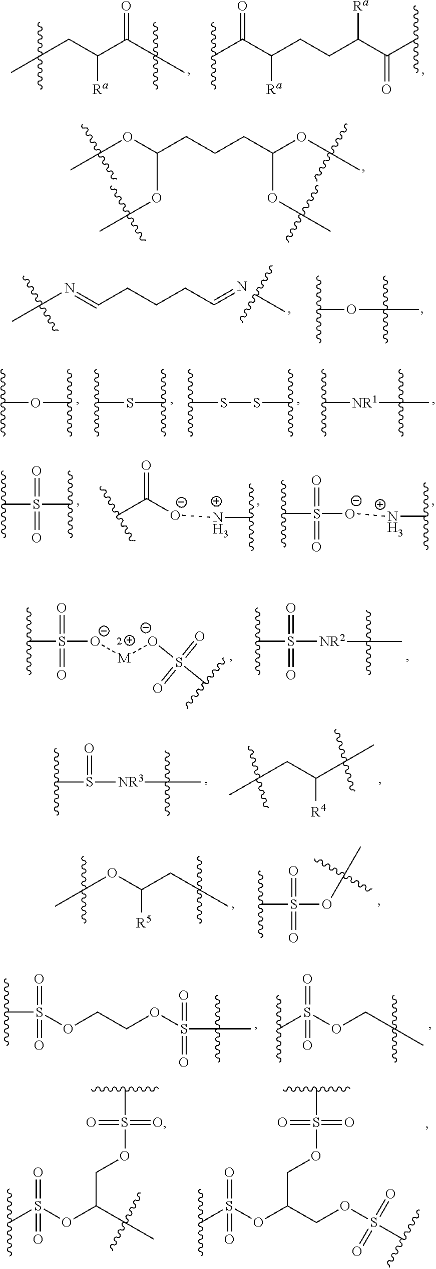 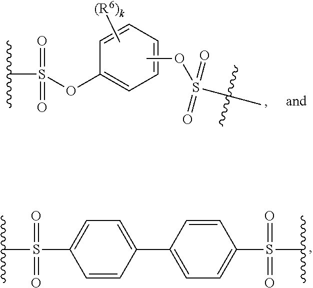
wherein:
each of R¹, R², R³, R⁴, and R⁵ is independently selected from H, C₁₋₁₂ alkyl, C₁₋₁₂haloalkyl, C₆₋₁₄ aryl, and C₆₋₁₄ aryl(C₁₋₁₂ alkylene);
R⁶ is H or —SO₃H,
R^{a} is H or C₁₋₁₂ alkyl;
M²⁺ is selected from Mr²⁺, Ca²⁺, Ba²⁺, and Al(X)²⁺, wherein X is halide, acetate, or nitrate; and
the symbol “ [symbol] ” represents a point of attachment of the crosslinking moiety to a repeat unit of the one or more first polymer.

38. The bilayer polyelectrolyte membrane of claim 37, wherein the crosslinking moiety is represented by one of the following structural formulas:

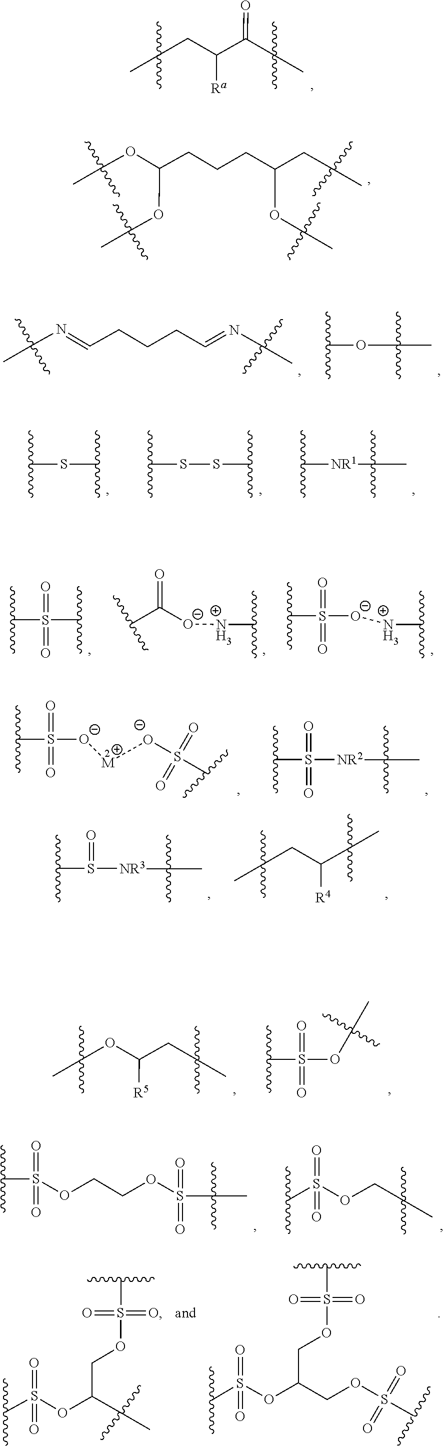

39. The bilayer polyelectrolyte membrane of claim 37, wherein the crosslinking moiety is represented by one of the following structural formulas:

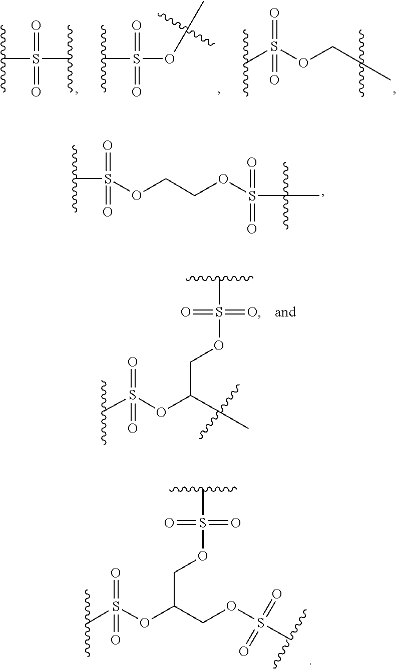

40. The bilayer polyelectrolyte membrane of claim 37, wherein the crosslinking moiety is represented by one of the following structural formulas:

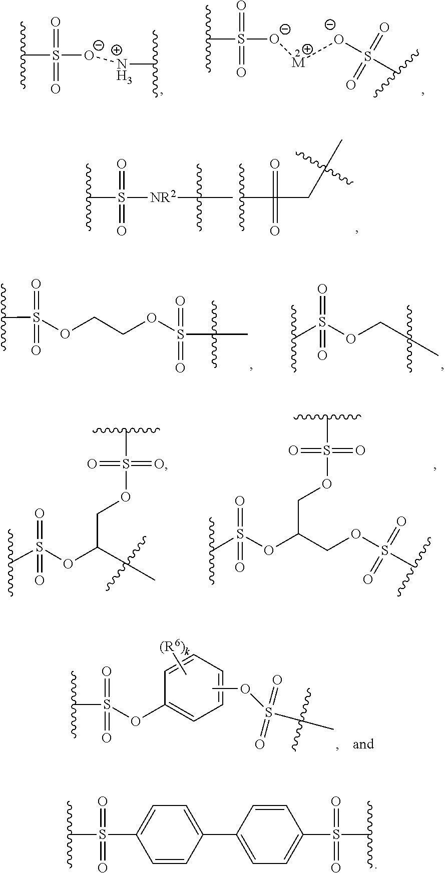

41. The bilayer polyelectrolyte membrane of claim 37, wherein the crosslinking moiety is represented by one of the following structural formulas:

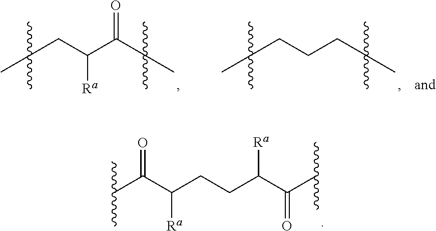

42. The bilayer polyelectrolyte membrane of claim 37, wherein the crosslinking moiety is represented by the following structural formula:

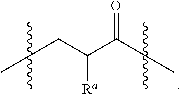

43. The bilayer polyelectrolyte membrane of claim 37, wherein the crosslinking moiety is represented by the following structural formula: or

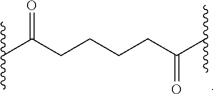 [SMILES: *C(=O)CCCCC(*)=O]

44. The bilayer polyelectrolyte membrane of any one of claims 1-43, wherein the degree of crosslinking of the first polymer is from about 10% to about 95%.

45. The bilayer polyelectrolyte membrane of claim 44, wherein the degree of crosslinking of the first polymer is about 70%.

46. The bilayer polyelectrolyte membrane of claim 44, wherein the degree of crosslinking of the first polymer is about 40%.

47. The bilayer polyelectrolyte membrane of any one of claims 1-46, wherein the first layer further comprises a porous matrix comprising a second polymer, and wherein the PFSA polymer and the second polymer form an interpenetrating network.

48. The bilayer polyelectrolyte membrane of claim 47, wherein the first layer comprises from about 70 wt. % to about 99 wt. % of the PFSA polymer.

49. The bilayer polyelectrolyte membrane of any claim 47 or 48, wherein the second polymer is PTFE.

50. The bilayer polyelectrolyte membrane of claim 49, wherein the second polymer is expanded PTFE.

51. The bilayer polyelectrolyte membrane of any one of claims 36-50, wherein the one or more first polymers have a gel fraction from about 50% to about 100%.

52. The bilayer polyelectrolyte membrane of any one of claims 1-51, wherein the first layer is from about 5 μm to about 175 μm thick.

53. The bilayer polyelectrolyte membrane of claim 52, wherein the first layer is about 25 μm thick.

54. The bilayer polyelectrolyte membrane of any one of claims 1-52, wherein the second layer is from about 0.2 μm to about 170 μm thick.

55. The bilayer polyelectrolyte membrane of claim 53, wherein the second layer is from about 0.2 μm to about 10 μm thick.

56. The bilayer polyelectrolyte membrane of claim 53, wherein the second layer is from about 0.5 μm to about 1 μm thick.

57. The bilayer polyelectrolyte membrane of claim 53, wherein the second layer is about 0.7 μm thick.

58. The bilayer polyelectrolyte membrane of any one of claims 1-57, wherein the first layer is continuous.

59. The bilayer polyelectrolyte membrane of any one of claims 1-58, wherein the second layer is continuous.

60. The bilayer polyelectrolyte membrane of any one of claims 1-59, wherein the membrane is unsupported.

61. The bilayer polyelectrolyte membrane of claim 1, wherein:
the first layer consists of PFSA, wherein the PFSA is a polymer comprising a repeat unit represented by structural formula (I): 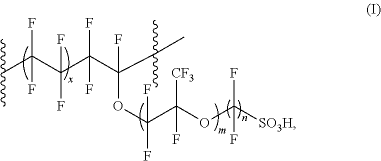
wherein:
x is an integer between 5 and 14,
m is 1 or 2, and
n is 2 or 3;
the metal oxide is CeO₂, and
the second layer further comprises crosslinked PEG comprising a crosslinking moiety represented by the following structural formula

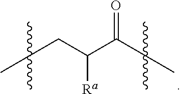

62. The bilayer polyelectrolyte membrane of claim 1, wherein:
the first layer consists of PFSA, wherein the PFSA is a polymer comprising a repeat unit represented by structural formula (I): 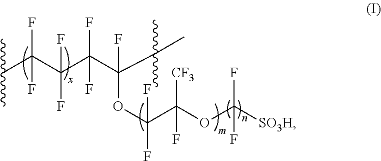
wherein:
x is an integer between 5 and 14,
m is 1 or 2, and
n is 2 or 3;
the metal oxide is CeO₂, and
the second layer further comprises crosslinked PEG(DA) comprising a crosslinking moiety represented by the following structural formula:

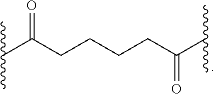 [SMILES: *C(=O)CCCCC(*)=O]

63. The bilayer polyelectrolyte membrane of claim 62, wherein:
the membrane is unsupported,
the crystalline particles of CeO₂ have a characteristic dimension of about 4 nm, and
the degree of crosslinking of crosslinked PEG(DA) is about 70%.

64. The bilayer polyelectrolyte membrane of claim 1, wherein:
the membrane is unsupported,
the PFSA is a polymer comprising a repeat unit represented by structural formula (I): 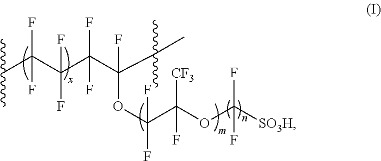
wherein
x is an integer between 5 and 14,
m is 1 or 2, and
n is 2 or 3; and further wherein
the metal oxide is CeO₂,
the second layer further comprises crosslinked sPPS comprising a crosslinking moiety represented by the following structural formula: 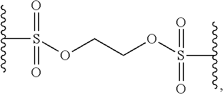 [SMILES: *S(=O)(=O)OCCOS(*)(=O)=O]
the degree of sulfonation of the sPPS is about 200%, and
the degree of crosslinking of the sPPS is about 40%.

65. The bilayer polyelectrolyte membrane of claim 1, wherein:
the membrane is unsupported,
the PFSA is a polymer comprising a repeat unit represented by structural formula (I): 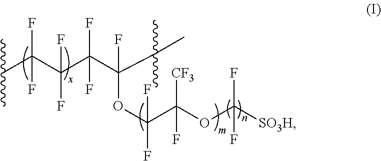
wherein
x is an integer between 5 and 14,
m is 1 or 2, and
n is 2 or 3; and further wherein
the metal oxide is CeO₂,
the second layer further comprises crosslinked sPPS comprising a crosslinking moiety represented by one of the following structural formula: 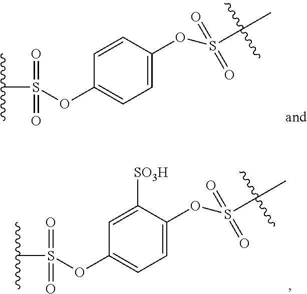 [SMILES: *S(=O)(=O)Oc1ccc(OS(*)(=O)=O)cc1 ; *S(=O)(=O)Oc1ccc(OS(*)(=O)=O)c(S(=O)(=O)O)c1]
the degree of sulfonation of the sPPS is about 200%, and
the degree of crosslinking of the sPPS is from about 25% to about 30.

66. The bilayer polyelectrolyte membrane of any one of claims 1-17, wherein:
the second layer further comprises a glass, and
the metal oxide is dispersed within the glass.

67. The bilayer polyelectrolyte membrane of claim 66, wherein the glass comprises niobium oxide, silica, tantalum oxide, tungsten oxide, vanadium oxide, or molybdenum oxide.

68. A method of making a bilayer polyelectrolyte membrane of any one of claims 1-65, comprising:
providing a first layer having a first side, and a suspension comprising a metal oxide and a solvent; and
coating the first side of the first layer with the suspension, thereby producing a coated first layer.

69. The method of claim 68, wherein the suspension comprises from about 0.01 v.% to about 74 v.% of the metal oxide.

70. The method of claim 69, wherein the suspension comprises about 0.4 v.% of the metal oxide.

71. The method of claim 68, wherein the suspension comprises from about 1 v.% to about 74 v.% of the metal oxide.

72. The method of claim 68, wherein the suspension comprises about 35 v.% of the metal oxide.

73. The method of any one of claims 68-73, wherein the suspension further comprises a first polymer.

74. The method of claim 73, wherein the suspension comprises from about 0.2 wt. % to about 25 wt. % of the first polymer.

75. The method of claim 74, wherein the suspension comprises about 0.5 wt. % of the first polymer.

76. The method of any one of claims 73-75, wherein the first polymer comprises a crosslinkable group.

77. The method of claim 76, wherein the crosslinkable group is selected from OH, NH₂, NH, SH, C(O)OH, C(O)Cl, C(O)Br, NHNH₂, N₃, S(O)₂OH, S(O)₂Cl, —NCO, —

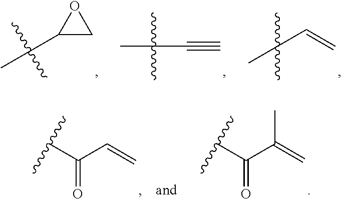

78. The method of claim 77, wherein the crosslinkable group is

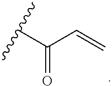 [SMILES: *C(=O)C=C]

79. The method of claim 77, wherein the crosslinkable group is S(O)₂OH.

80. The method of any one of claims 68-79, wherein the suspension further comprises a crosslinking initiator.

81. The method of claim 80, further comprising a step of crosslinking the first polymer under conditions sufficient for the crosslinking initiator to initiate the crosslinking of the first polymer.

82. The method of claim 81, wherein the conditions sufficient for the crosslinking initiator to initiate the crosslinking of the first polymer comprise visible light irradiation, UV light irradiation, application of heat, microwave irradiation, ultrasound, or gamma-ray irradiation.

83. The method of any one of claims 80-82, wherein the crosslinking initiator is selected from 2,2-dimethoxy-2-phenylacetophenone (DMPA), azobisisobutyronitrile (AIBN), and benzoyl peroxide (BPO).

84. The method of any one of claims 80-83, wherein the suspension comprises from about 0.5 wt. % to about 50 wt. % of the crosslinking initiator.

85. The method of claim 84, wherein the suspension comprises about 5 wt. % to about 15 wt. % of the crosslinking initiator.

86. The method of any one of claims 68-79, wherein the suspension further comprises a crosslinking reagent.

87. The method of any claim 86, further comprising a step comprising reacting the first polymer with the crosslinking reagent under conditions sufficient for the first polymer and the crosslinking reagent to undergo a crosslinking reaction.

88. The method of claim 87, wherein the conditions sufficient for the first polymer and the crosslinking reagent to undergo a crosslinking reaction comprise irradiation with visible light, irradiation with UV light, and/or application of heat.

89. The method of claim 88, the conditions sufficient for the first polymer and the crosslinking reagent to undergo a crosslinking reaction comprise heating the coated first layer to a crosslinking temperature from about 150° C. to about 200° C. for a crosslinking time from about 2 hours to about 96 hours.

90. The method of claim 99, wherein the crosslinking temperature is about 180° C.

91. The method of claim 89 or 90, wherein the crosslinking time is about 4 hours.

92. The method of any one of claims 86-91, wherein the crosslinking reagent is selected from a polyalcohol, an aldehyde, an amine, an epoxide, a thiol, or a compound comprising a terminal alkene or alkyne.

93. The method of any one of claims 86-91, wherein the crosslinking reagent is selected from glycerol, ethylene glycol, hydroquinone, 2,5-dihydroxybenzenesulfonic acid, 2,5-dihydroxybenzene-1,4-disulfonic acid, biphenyl, tetraglycidyl bis(p-aminophenyl)methane, phenylene diamine, 4,4′-thiobisbenzenethiol, and tetrafluoro styrene.

94. The method of claim 93, wherein the crosslinking reagent is selected from glycerol, ethylene glycol, tetraglycidyl bis(p-aminophenyl)methane, phenylene diamine, 4,4′-thiobisbenzenethiol, glutaraldehyde, styrene, and tetrafluoro styrene.

95. The method of claim 92, wherein the crosslinking reagent is a polyalcohol.

96. The method of claim 92, wherein the crosslinking reagent is ethylene glycol or glycerol.

97. The method of claim 92, wherein the crosslinking reagent is hydroquinone or 2,5-dihydroxybenzenesulfonic acid.

98. The method of any one of claims 68-97, wherein coating the first side of the first layer with the suspension comprises spray-coating, spin coating, drop-casting, zone casting, dip coating, blade coating, printing, vacuum filtration, slot die coating, curtain coating, or a combination thereof.

99. The method of claim 98, wherein coating the first side of the first layer with the suspension comprises spray-coating.

100. The method of any one of claims 68-99, wherein the solvent is selected from dimethylformamide, tetrahydrofuran, N-methylformamide, formamide, acetonitrile, dimethylacetamide, propylene carbonate, ethylene carbonate, N-methylpyrrolidone, dimethylsulfoxide, or a combination thereof.

101. The method of claim 100, wherein the solvent is dimethylformamide.

102. A membrane electrode assembly (MEA), comprising:
the bilayer polyelectrolyte membrane of any one of claims 1-67;
a cathode; and
an anode,
wherein the bilayer electrolyte membrane is disposed between the anode and the cathode.

103. The MEA of claim 102, wherein the cathode is disposed on the first layer of the bilayer electrolyte membrane and the anode is disposed on the second layer of the bilayer electrolyte membrane.

104. The MEA of claim 102, wherein the anode is disposed on the first layer of the bilayer electrolyte membrane and the cathode is disposed on the second layer of the bilayer electrolyte membrane.

105. A fuel cell, comprising one or more of the MEAs of any one of claims 102-104 and one or more gas flow bipolar plates.
